(19) United States
(12) Patent Application Publication
(10) Pub. No.: US 2025/0034404 A1
(43) Pub. Date: Jan. 30, 2025

(54) THICK PHOTO-PATTERNABLE HYBRID INORGANIC MATERIALS

(71) Applicant: Meta Platforms Technologies, LLC, Menlo Park, CA (US)

(72) Inventor: Alejo LIFSCHITZ ARRIBIO, Redmond, WA (US)

(21) Appl. No.: 18/786,347

(22) Filed: Jul. 26, 2024

Related U.S. Application Data
(60) Provisional application No. 63/516,128, filed on Jul. 27, 2023.

(51) Int. Cl. C09D 1/00; C09D 7/20; C09D 7/61; C09D 133/04; C09D 183/04; G03H 1/02; G03H 1/04

(52) U.S. Cl. CPC C09D 1/00; C09D 7/20; C09D 7/61; C09D 133/04; C09D 183/04; G03H 1/0248; G03H 1/0402; G03H 2001/0268; G03H 2001/0413; G03H 2001/0439; G03H 2260/12; G03H 2260/33

(57) ABSTRACT

Techniques disclosed herein relate to photo-patternable latent-chemistry inorganic materials. An example of the photo-patternable latent-chemistry inorganic materials includes a sol-gel material comprising a solution containing a tin dichloride salt, at least one alcohol containing solvent, and optionally a photo-acid generator or photo-acid. The sol-gel material, upon selective photo-excitation (which forms a latent pattern with latent chemistry in the sol-gel material) and blanket thermal annealing, can form a coating having a formula SnO(n)X(m), where the n:m ratio and/or n-m values of the coating vary across regions of the coating, such that a refractive index of the coating varies across regions of the coating, without affecting the coating's transparency for visible light.

### CROSS-REFERENCE TO RELATED APPLICATION

This application claims the benefit of and priority to U.S. Provisional Application No. 63/516,128, filed Jul. 27, 2023, entitled “THICK PHOTO-PATTERNABLE HYBRID INORGANIC MATERIALS,” which is incorporated herein by reference in its entirety.

### BACKGROUND

An artificial reality system, such as a head-mounted display (HMD) or heads-up display (HUD) system, generally includes a near-eye display system in the form of a headset or a pair of glasses and is configured to present content to a user via an electronic or optic display within, for example, about 10-20 mm in front of the user's eyes. The near-eye display system may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through).

One example of an optical see-through AR system may use a waveguide-based optical display, where the light of projected images may be coupled into a waveguide (e.g., a transparent substrate), propagate within the waveguide, and be coupled out of the waveguide at different locations. In some implementations, the light of the projected images may be coupled into or out of the waveguide using a diffractive optical element, such as a holographic grating. In some implementations, the artificial reality systems may employ eye-tracking subsystems that can track the user's eye (e.g., gaze direction) to modify or generate content based on the direction in which the user is looking, thereby providing a more immersive experience for the user. The eye-tracking subsystems may be implemented using various optical components, such as holographic optical elements or surface-relief structures.

Sol-gels are materials composed of a solution comprising a metal oxide precursor that may have been partially or fully condensed into an extended network. Upon depositing the solution and annealing the sol-gel, the precursor ligands and solvent may be removed to fully condense the extended network into an oxide or inorganic film. The condensation process may result in densification and, potentially, crystallization. Thus, when applied onto a substrate and annealed, sol-gels can be used to manufacture transparent, high refractive-index (RI) coatings.

### SUMMARY

This disclosure relates generally to photo-patentable sol-gel materials. According to certain aspects, a sol-gel material may include a solution containing a tin dichloride salt, a solvent including at least one alcohol-containing solvent, optional photo-sensitizer, and metal oxide nanoparticles, where the sol-gel material is configurable to form a coating characterized by a formula SnO(n)X(m), where the n:m ratio and n and m values of the coating may vary across regions of the coating as a result of selective photo-excitation followed by blanket thermal annealing, such that a refractive index of the coating may vary across regions of the coating.

In some embodiments of the sol-gel material, each of the metal oxide nanoparticles may have a core including TiO₂, Nb₂O₅, Ta₂O₅, ZrO₂, HfO₂, SnO₂, SnO, ZnS, ZnO, SiO₂, Al₂O₃, or BaTiO₃. In some embodiments, each of the metal oxide nanoparticles may include a passivating metal oxide shell of ZrO₂, HfO₂, ZnS, SiO₂, Al₂O₃, ZnO, or Ta₂O₅. In some embodiments, surfaces of the metal oxide nanoparticles in the sol-gel material may be passivated with phosphate, siloxane, or silicate species. In some embodiments, the surfaces of the metal oxide nanoparticles may be treated with organic species with low Sn-coordination strength to prevent aggregation. In some embodiments, the surfaces of the metal oxide nanoparticles may be treated with methacrylate or acrylate-containing species.

In some embodiments of the sol-gel material, the tin dichloride salt may include at least one of: anhydrous tin dichloride, tin dichloride hydrate, or tin(II) ions and chloride ions from separate salts. The solvent of the sol-gel material may include alkyl alcohol, glycol, diol, or a combination thereof. In some embodiments, the solvent of the sol-gel material may include a solvent mixture containing at least one of dipropylene glycol monomethyl ether (DPGME), propylene glycol monomethyl ether (PGME), ethanol, isopropanol, propanol, diethylene glycol, propylene glycol methyl ether acetate, tripropylene glycol monomethyl ether, butyl lactate, propylene carbonate, methanol, or water.

In some embodiments, the photo-sensitizer of the sol-gel material may include a photo-acid generator, or photo-acid. In some embodiments, the photo-acid generator or photo-acid may include at least one of a triarylsulfonium compound, a diazomethane compound, a bis(sulfonyl)diazomethane compound, a diaryliodonium compound, a triarylselenonium compound, an arene ferrocence compound, or a sulfonic acid ester compound.

In some embodiments of the sol-gel material, the coating, after the selective photo-excitation and blanket thermal annealing, is characterized by refractive indices between about 1.5 and 2.35, and has absorption values less than about 0.1% in the visible spectrum across the coating.

In some embodiments, an optical coating layer includes SnO(n)X(m) and metal oxide nanoparticles. The m and n values, m:n ratio, and the resultant local refractive index values of the optical coating layer may be controlled by at least the intensity, exposure time, and wavelength of photo-excitation followed by thermal annealing.

In some embodiments, an optical coating layer includes SnO(n)X(m) and metal oxide nanoparticles, and has variable n and m values and/or n:m ratio resultant from selective photo-curing and a subsequent thermal annealing process, where a refractive index of the optical coating layer may vary from about 1.65 to about 2.35, and all portions of the optical coating layer may have absorption values lower than about 0.1% for visible light.

In some embodiments, an optical coating layer includes SnO(n)X(m) and metal oxide nanoparticles, where photo-exposed regions of the optical coating layer are characterized by refractive index values lower than refractive index values of non-photo-exposed regions. For example, the photo-exposed regions may be characterized by refractive index values between about 1.5 and 2.0 and the m:n ratio greater than about 3.

In some embodiments, a method may include depositing a sol-gel material layer on a substrate via spin-coating, ink-jet printing, dip-coating, spray-coating, screen-printing, contact-printing, or casting. The method may also include: (1) exposing at least a portion of the sol-gel material layer using a light source with an excitation wavelength >193 nm and intensity ≤300 mW/cm² for 0.001 to 600 seconds, such that photo-exposed areas have a lower refractive index value than non-exposed areas upon thermal annealing; (2) photo-curing at least a portion of the deposited sol-gel material layer using a pattern of constructive and destructive interference to create a pattern of periodic variation in RI and thickness within the coating after thermal annealing; (3) photo-reacting at least a portion of the deposited sol-gel material layer through a binary mask with features ranging between about 100 nm and about 20 cm in feature dimensions to create a pattern of periodic variation in the refractive index; or (4) exposing the sol-gel material layer to an interference light pattern to create a holographic optical element within the sol-gel material layer upon thermal annealing. The method may further include (1) thermally annealing the sol-gel material layer via at least one stage of thermal annealing at annealing temperatures lower than about 300° C. after photo-excitation, or (2) annealing the sol-gel material layer via at least two stages of annealing, where the initial annealing may be performed at temperatures below about 150° C. before or after the photo-excitation step, and the final anneal may be performed at temperatures below about 300° C., to produce an annealed, transparent coating with local variations in RI at least about 0.1 and the overall RI variability taking place in the range of RI about 1.50-2.35.

According to certain aspects, a sol-gel material may include a solution containing a tin dichloride salt, at least one alcohol-containing solvent, optional photo-sensitizer, and a resin mixture, where the sol-gel material is configurable to form a coating characterized by a formula SnO(n)X(m), where the n:m ratio and n and m values of the coating vary across regions of the coating as a result of selective photo-excitation followed by blanket thermal annealing, such that a refractive index of the coating varies across regions of the coating.

In some embodiments of the sol-gel material, the resin mixture may include at least one of a thermal silicone, an UV acrylate, an UV methacrylate, or an UV sulfide. In some embodiments, the tin dichloride salt may include at least one of an anhydrous tin dichloride, a tin dichloride hydrate, or tin(II) ions and chloride ions from separate salts. In some embodiments, the solvent for the sol-gel material may include an alkyl alcohol, a glycol, a diol, or a combination thereof. In some embodiments, the solvent may be a solvent mixture including at least one of dipropylene glycol monomethyl ether (DPGME), propylene glycol monomethyl ether (PGME), ethanol, isopropanol, propanol, diethylene glycol, propylene glycol methyl ether acetate, tripropylene glycol monomethyl ether, butyl lactate, propylene carbonate, methanol, or water. In some embodiments, the sol-gel material may include a photo-sensitizer such as a photo-acid generator, a photo-base generator, a photo-redox agent, or a radical initiator.

In some embodiments, the sol-gel material may include a poly alkyl/aryl siloxane oligomer of Structure 1, a hardener or crosslinking agent of Structure 2, a cross-linker of Structure 3, a catalyst, and optionally an organic solvent. In the structures, R₁ and R₂ are hydrogen groups, alcohol groups, or both. R₃-R₈ are alkoxide, alkyl, or aryl groups, or a mixture of the three groups, where the alkoxide, alkyl, or aryl is composed of a chain of about 1-9 carbon atoms. The chains are either linear or branched, and n is about 0-50. Each of R₉-R₁₂ includes hydrogen, alcohol, alkyl, aryl, alkoxide, or a combination thereof, where the alkyl, aryl, or alkoxide is composed of a chain of about 1-9 carbon atoms, and the chains are either linear or branched. R₁₃ is an alkyl group or aryl group containing about 1-9 carbon atoms. R₁₄ is an alkoxide, bisalkoxide, alkyl, or aryl group containing about 0-8 carbon atoms. Each of R₁₅-R₁₇ includes hydrogen, alcohol, alkyl, aryl, alkoxide, or a combination thereof, where the alkyl, aryl, or alkoxide is composed of a chain of about 1-9 carbon atoms, the chains are either linear or branched, and m is about 2-4.

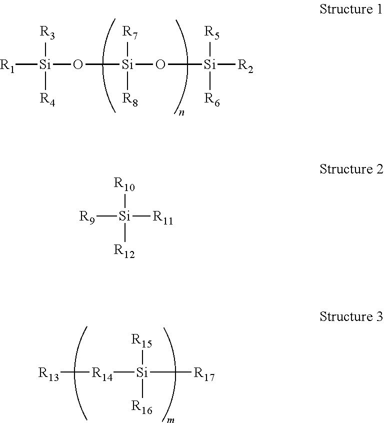

In some embodiments, the sol-gel material includes a polyacrylate or a polymethacrylate compound of Structure 4, a cross-linker of Structure 5, a cross-linker of Structure 6, a catalyst, and optionally, an organic solvent, where R₁₈ is hydrogen or methyl, R₁₉ is a C2 fragment with a carbon-carbon double bond, R₂₀ is an alkyl or aryl chain containing about 1-15 carbon atoms, R₂₁ is an alkyl group or aryl group containing about 1-8 carbon atoms, R₂₂ is an alkyl group or aryl group containing about 0-8 carbon atoms, R₂₃ is hydrogen or methyl, o is 2-4, R₂₄ is an alkyl or aryl chain containing about 1-15 carbon atoms, R₂₅ is an alkyl group or aryl group containing about 1-8 carbon atoms, R₂₆ is an alkyl group or aryl group containing about 0-8 carbon atoms, and p is about 2-4.

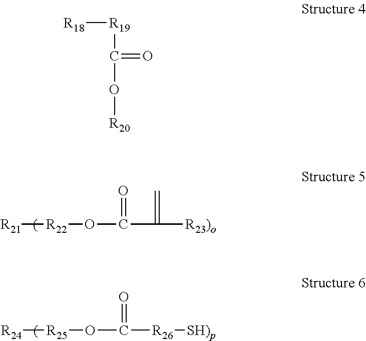

In some embodiments, the sol-gel material coating, after selective photo-excitation and blanket thermal annealing, is characterized by a refractive index between about 1.65 and 2.35 and absorption values in the visible spectrum less than about 0.1% across the coating.

In some embodiments, an optical coating layer includes SnO(n)X(m), where m and n values, m:n ratio, and resultant local refractive index values are controlled by intensity, exposure time, and/or wavelength of photo-excitation followed by thermal annealing.

In some embodiments, an optical coating layer includes SnO(n)X(m) with variable n and m values and n:m ratio resultant from selective photo-curing and a subsequent thermal annealing process, where a refractive index of the optical coating layer may vary from about 1.65 to 2.35, and all portions of the optical coating layer may have absorption values lower than about 0.1% for visible light.

In some embodiments, an optical coating layer includes SnO(n)X(m), where photo-exposed regions of the optical coating layer are characterized by refractive index values lower than refractive index values of non-photo exposed regions. For example, the photo-exposed regions may have refractive index values between about 1.5-2.0, and the m:n ratio may be greater than about 3.

In some embodiments, an optical coating layer includes SnO(n)X(m), and silicone, polyacrylate, polymethacrylate, polysulfide resin, or a combination thereof, where the optical coating layer, after selective photo-excitation and blanket thermal annealing and optional photo-cure, is characterized by a final thickness greater than about 1000 nm and a refractive index value between about 1.55-2.20, where all portions of the optical coating layer have absorption values lower than about 0.1% for visible spectrum.

In some embodiments, a method includes depositing a sol-gel material layer on a substrate via spin-coating, ink-jet printing, dip-coating, spray-coating, screen-printing, contact-printing, or casting, the sol-gel material layer including the sol-gel material disclosed herein. The method also includes exposing at least a portion of the sol-gel material layer using a light source with an excitation wavelength greater than about 365 nm and an intensity no more than 300 mW/cm² for about 0.001 to 300 seconds, such that the photo-exposed areas have a lower refractive index value than non-exposed areas upon thermal annealing. In some embodiments, the sol-gel material layer may be exposed to an interference light pattern to create a holographic optical element within the sol-gel material layer upon thermal annealing. The method may further include thermally annealing the sol-gel material layer via at least one stage of thermal annealing at a annealing temperature lower than about 300° C. after the photo-excitation, or optionally at least two stages of annealing, where the initial annealing may be performed before or after the photo-excitation step at temperatures lower than about 200° C., and the final anneal may be performed at temperatures below about 300° C., to produce an annealed, transparent coating with a local RI varies by at least about 0.05 and the overall RI variability taking place in the range of about 1.55-2.20.

### BRIEF DESCRIPTION OF THE DRAWINGS

Illustrative embodiments are described in detail below with reference to the following figures.

FIG. 1 is a simplified block diagram of an example of an artificial reality system environment including a near-eye display system according to certain embodiments.

FIG. 2 is a perspective view of an example of a near-eye display system in the form of a head-mounted display (HMD) device for implementing some of the examples disclosed herein.

FIG. 3 is a perspective view of an example of a near-eye display system in the form of a pair of glasses for implementing some of the examples disclosed herein.

FIG. 4 illustrates an example of an optical see-through augmented reality system using a waveguide display that includes an optical combiner according to certain embodiments.

FIG. 5A illustrates an example of a volume Bragg grating (VBG). FIG. 5B illustrates the Bragg condition for the volume Bragg grating shown in FIG. 5A.

FIG. 6 illustrates an example of a holographic recording material including two-stage photopolymers.

FIG. 7A illustrates the recording light beams for recording a volume Bragg grating and the light beam reconstructed from the volume Bragg grating. FIG. 7B is an example of a holography momentum diagram illustrating the wave vectors of recording beams and reconstruction beams and the grating vector of the recorded volume Bragg grating.

FIG. 8 illustrates an example of a holographic recording system for recording holographic optical elements.

FIGS. 9A-9D illustrate an example of free radical polymerization in an example of a photopolymer material. FIG. 9A illustrates the photopolymer material before polymerization. FIG. 9B illustrates the initiation of monomer chains. FIG. 9C illustrates the propagation of the monomer chains. FIG. 9D illustrates the termination of the monomer chains.

FIGS. 10A-10C illustrate an example of recording a holographic optical element in an uncontrolled photopolymer material layer. FIG. 10A illustrates the unexposed photopolymer material layer. FIG. 10B illustrates monomer diffusion and polymerization during the holographic recording. FIG. 10C illustrates an example of polymer diffusion after exposure.

FIG. 11 illustrates an example of a process of generating RI modulation in a thick optical film.

FIG. 12 illustrates an example of photo-patterning via latent chemistry behavior following photo-exposure.

FIGS. 13A-13E illustrate examples of materials and processes for recording holographic optical elements (e.g., VBG) or holographic patterns.

FIG. 14 illustrates an example of a process of fabricating an optical device using a thick photo-patternable hybrid resin-sol-gel material layer with selective photo-activation and refractive index modulation by latent chemistry.

FIG. 15 illustrates an example of a process that may be utilized to form SRG gratings and grating fill layers.

FIG. 16 illustrates an example of photo-patterning via latent chemistry following photo-exposure through a mask to create surface-relief grating (SRG)-like patterns.

FIG. 17 illustrates an example of a process of fabricating optical devices using photo-patternable sol-gel material incorporating high-RI nanoparticles with selective photo-activation and refractive index modulation by latent chemistry.

FIGS. 18-29 illustrate examples of experimental results.

FIG. 30 is a simplified block diagram of an example of an electronic system of a near-eye display system (e.g., HMD device) for implementing some of the examples disclosed herein according to certain embodiments.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Techniques disclosed herein relate generally to sol-gel materials for fabricating diffractive optical elements (e.g., holographic optical elements), where a refractive index (RI) of the sol-gel material may be modulated by photo-excitation and thermal annealing. More specifically, new materials and processing conditions based on tin (Sn) and photo-acid generator photochemistry for fabricating thick (e.g., >1000 nm) optical coatings are disclosed herein. Some techniques disclosed herein relate to photo-patternable, latent-chemistry-activated inorganic hybrid-resin-sol-gel materials. The hybrid-resin-sol-gel materials may include a resin mixture incorporating a thermal silicone, a UV acrylate, or a UV sulfide. Some techniques disclosed herein relate to photo-patternable, latent-chemistry-activated sol-gel materials, such as SnO(n)Cl(m), incorporating metal oxide nanoparticles. The sol-gel materials may be transparent and may stay in an amorphous state without any noticeable domain formation. The sol-gel materials disclosed herein may achieve highly condensed states with RI values in a range of up to about 1.6-2.35, depending on the m and n values and the m:n ratio, such as RI values ranging from about 1.6 to about 2.0 when the m:n ratio is more than 3. The RI of an optical coating including the SnO(n)Cl(m)-based sol-gel material may depend on the chemical environment around the tin (Sn) centers prior to the thermal anneal, which may change the thickness of the optical coating. Upon post-processing after photo-exposure, the RI of the optical coating may change substantially as a result of relevant chemical changes around Sn centers. In some embodiments, the photochemistry of the Sn may trigger the RI change. In some embodiments, Sn may be used in conjunction with photo-acid generators, photo-based generators, photo-redox agents, radical-initiators, and/or photo-sensitizers. Various inventive embodiments are described herein, including devices, systems, methods, materials, processes, compositions, and the like.

In various optical systems, such as artificial reality systems including virtual reality, augmented reality (AR), and mixed reality (MR) systems, to improve the performance of the optical systems, such as improving the brightness of the displayed images, expanding the eyebox, reducing artifacts, increasing the field of view, and improving user interaction with presented content, holographic optical elements may be used for light beam coupling and shaping, such as coupling light into or out of a waveguide display or tracking the motion of the user's eyes. These holographic optical elements may need to have a high refractive index modulation, a small pitch or feature size, high clarity, high diffraction efficiency, and the like.

Photo-reactive materials that can have a local change in refractive index upon light excitation can be used to record Volume Bragg Gratings (VBG), holographic pattern, or create RI gradients in an optical film or coating. These materials can thus be used as waveguide (WG) display devices or components in VR/AR/MR display systems, where the photo-generated pattern may control the refraction and diffraction efficiency of light as it travels through the coating. In order to increase the efficiency of the WG display device, the WG display device may need to have certain characteristics.

For example, it may be desirable that the WG display device (e.g., a holographic grating coupler) has a large RI contrast or RI modulation (Δn) between photo-exposed areas and unexposed areas (e.g., Δn>0.05), because the higher the Δn, the higher the diffraction efficiency the WG device may achieve. Furthermore, both the photo-exposed and unexposed areas need to be transparent to visible light (e.g., with absorption <0.1%/100 nm) after the material is fully processed because, for the coating to allow total internal reflection (TIR) and allow ambient light to pass through with minimal absorption losses, it is desirable that the material has a low or minimum absorption of the light traveling through it. If either the photo-exposed or unexposed areas can absorb visible light, the efficiency of the WG display may be lowered. In addition, the thickness difference between photo-exposed and unexposed areas needs to be minimized (e.g., <20% of total coating thickness) to prevent surface scattering and diffraction, because variations in coating thickness along the length of the WG may lead to optical artifacts, such as ghost images, or decreased image quality, such as pupil swim. Furthermore, periodic variations in the coating thickness due to, for example, distinct thickness changes in the exposed regions, may create surface relief gratings having their own diffractive behaviors that may disrupt the functionality of the overall WG display system.

In addition, it is desirable that the photo-exposure leads to a pattern of chemical or thermal reactivity that only produces a distinct change in RI after the material undergoes post-processing. This behavior is referred to as photo-induced latent chemistry, where the photo-exposure process itself does not lead to a significant change in RI. Instead, it leaves behind a pattern of reactivity that is exploited in a subsequent step, such as thermal annealing. This latent chemistry behavior is desirable when undergoing photo-exposure via light patterns formed by constructive and destructive interference or when it is desirable to achieve nano-scale resolution between photo-exposed and unexposed areas. The reason is that the generation of a local Δn during the photo-exposure may cause the diffraction of light that is used to photo-pattern the material, thereby leading to parasitic grating formation or other aberrations in the diffraction and refraction behavior of the pattern. By de-coupling photo-excitation and Δn formation into two separate processing steps (photo-excitation and post-processing), the photo-reactive material can be exposed for as long as needed, without compromising the quality of the refractive index modulation pattern.

Furthermore, it is desirable that the photo-excitation or post-processing would not entail long-range (e.g., >10 nm) reorganization of components within the material, so as to prevent potential scattering issues. If the photo-exposure or post-processing results in displacement of a given component, such as a particle or a growing organic polymer chain, there may be a significant risk that the components may agglomerate into units that are larger than about 1/10 of the wavelength of light. As a result, the agglomerates may scatter light as the light travels through the optical coating, and the image quality of the WG display may be severely impacted.

Therefore, there is a need for materials that can be incorporated into WG devices as optical coatings, and can react to photo-excitation by creating a pattern of latent chemistry that leads to a large Δn upon post-processing. It is desirable that these materials are fully transparent in both photo-exposed and nonexposed areas once post-processing is completed, and have minimal thickness variations within all areas of the coating after the processing.

According to certain embodiments, a sol-gel material for recording holographic optical elements (e.g., volume Bragg gratings) may include a (precursor) solution containing a tin dichloride salt, at least one alcohol-containing solvent, and optionally a photo-acid generator or photo-acid. The sol-gel material may be used to form a continuous coating characterized by a formula SnO(n)X(m) as a result of selective photo-excitation followed by blanket thermal annealing, where the n-m ratio and n and m values may vary across regions of the coating, such that the local RI of the coating is actively varied without affecting the coating's transparency.

In some embodiments, the tin dichloride salt may include anhydrous tin dichloride, tin dichloride hydrate, or tin(II) ions and chloride ions provided to the solution from separate salts. The solvent may include at least one alcohol, such as an alkyl alcohol, a glycol, or a diol. The solvent may be a solvent mixture that may include at least one of dipropylene Glycol Monomethyl Ether (DPGME), propylene Glycol Monomethyl Ether (PGME), ethanol, isopropanol, propanol, and diethylene glycol, propylene glycol methyl ether acetate, tripropylene glycol monomethyl ether, butyl lactate, propylene carbonate, methanol, or water. The coating solution may optionally include a photo-acid generator or photo-acid. The photo-acid generator or photo-acid may include at least one of a diarylsulfonium compound, a diazomethane compound, a bis(sulfonyl)diazomethane compound, a Diaryliodonium compound, a triarylselenonium compound, an arene ferrocene compound, or a sulfonic acid ester compound.

In some embodiments, a coating may be prepared from the sol-gel precursor solution to form a layer composed of SnO(n)X(m). The coating, once thermally annealed and optionally photo-cured, may have an RI between about 1.65 and about 2.35, where all portions of the coating may have absorption values <0.1% in the visible spectrum. In some embodiments, a coating composed of SnO(n)X(m) with variable n and m values and n:m ratio may be resulted from selective photo-curing of the coating prior to the thermal annealing process, such that local RI values may vary from about 1.65 to 2.35 and all portions of the coating may have absorption values <0.1% in the visible spectrum. In some embodiments, a coating may include photo-exposed regions having RI values that are lower than those of the non-photo-exposed regions, and the photo-exposed regions may have a refractive index value of about 1.5 to 2.0, and an m:n ratio >3. In some embodiments, the m and n values, m:n ratio, and the resultant local RI values of a coating disclosed herein may be controlled by the intensity, exposure time, and wavelength of the photo-excitation followed by thermal annealing.

In some embodiments, a process may include applying the sol-gel precursor solution disclosed herein onto a substrate via spin-coating, ink-jet printing, dip-coating, spray-coating, screen-printing, contact-printing, or casting, to form a coating layer. At least a portion of the coating layer may be cured using a light source with an excitation wavelength >365 nm and an intensity no more than 300 mW/cm² for 0.001 to 300 seconds, such that the photo-exposed areas may have a lower RI value than the non-exposed areas after thermal annealing. In some embodiments, at least a portion of the coating layer may be photo-cured using a light pattern formed by constructive and destructive interference to create a latent holographic optical element (e.g., VBG) within the coating before thermal annealing. The substrate with the photo-cured coating layer may be thermally annealed via at least one stage of thermal annealing after photo-excitation, at annealing temperatures <300° C., or may optionally be thermally annealed via at least two stages of annealing, where the initial anneal may occur before or after the photo-excitation step, the temperature of the first anneal step is <200° C., and the temperature of the final anneal step is <300° C. After the thermal annealing, a transparent coating with local variations in RI may be formed, where the local RI may vary by at least 0.1 (refractive index modulation) and the overall RI may vary in the range of 1.65-2.35.

The SnO(n)Cl(m) coatings containing photo-acid generator (PAG) can be photo-patterned to produce large changes in local RI. However, sol-gel coatings may have poor uniformity and mechanical stability when the thickness is increased beyond a certain threshold. For SnO(n)Cl(m) coatings deposited via spin-coating, the threshold may be less than about 600 nm. When the thickness of the coating approaches the threshold, the film may become highly uneven (e.g., with >10% thickness variations across the material layer). This variation in thickness may prevent the even recording of RI patterns while keeping an acceptable patterned feature shape. In addition, the thickness variation may introduce local variations in the way light is modified by the waveguide, thus decreasing the optical quality of the device. As the thicknesses of SnO(n)Cl(m) coatings deposited via spin-coating approach 600 nm, the coatings may show haze. This may be caused by scattering from grain and crack formation during film annealing, which may, in turn, be the consequence of the inherent shrinking behavior of sol-gels as they are cured. The shrinking process may cause some build-up of strain in the coating as the sol-gel shrinks at high temperatures. In general, the thicker the coatings, the higher the stress build-up may be. Thus, when the stress crosses an upper threshold determined by the specific sol-gel material properties, the stress may need to be relieved via crack formation. For optical coatings for waveguide display applications, cracks are an unacceptable defect that disrupts the flow of light through the device, decreasing waveguide display efficiency and decreasing image quality.

According to certain embodiments, the thickness and thickness variation limitations of the SnO(n)Cl(m) coatings can be addressed by incorporating a resin matrix, such as a thermal silicone, a UV acrylate, or a UV sulfide component, into the coating precursor. In one example, the silicone may include two components. The first component may include a poly alkyl/aryl siloxane monomer terminated with hydride or alcohol groups. The second component may include a hardener or crosslinking agent, such as a tetraalkoxidesilane or a multi-siloxane-containing molecule; a catalyst, such as a platinum or tin compound or other Lewis acidic moieties; and optionally an organic solvent. The two silicone components can be mixed with the sol-gel without leading to component precipitation, and the mixture can be coated via spin-coating. The initial thermal dry and sol-gel photo-patterning steps can be completed without triggering silicone resin cure. In the final high-temperature anneal, both the silicone and patterned sol-gel are cured to set the coating at high thickness, low thickness variation (e.g., <5%), and good coating quality.

The UV acrylate or UV sulfide resin may include an acrylate or methacrylate monomer or oligomer containing one or more aryl or thioether groups; a cross-linker unit comprising a molecule containing two or more acrylate or methacrylate groups, or two or more thiol groups; a photo-initiator comprising a phosphine oxide or phosphonic acid containing alkyl, aryl and/or acyl groups; an adhesion promoter comprising a silane or siloxane compound containing one or more alcohol or alkoxide groups and one or more alkyl or aryl groups bonded to the silicon center; and optionally an organic solvent. The UV acrylate components can be mixed with the sol-gel without leading to component precipitation, and the mixture can be coated via spin-coating. The initial thermal dry may not trigger the polymerization of the resin matrix. The sol-gel photo-patterning step induces some cross-linking for both resin and sol-gel, but the sol-gel reactivity occurs significantly faster, enabling a significant degree of orthogonality. In the final high-temperature anneal, the sol-gel is condensed, and some of the resin also undergoes further reactivity, allowing one to set the film at high thickness, low thickness variation (<5%), and good coating quality.

The resin can be mixed with solutions containing tin dichloride and an alcohol-containing solvent or solvent mixture, and optionally a photo-sensitizer such as a photo-acid generator, photo-base generator, photo-redox agent, or radical-initiator. This combination may allow one to maintain film photo-reactivity while increasing the thickness range for high-quality coatings to 1000 nm or higher.

In some implementations, when patterning a coating layer of a mixture, the ability of the mixture to diffuse prior to final annealing means that the ability to retain pattern feature shapes with high fidelity is limited to the micron range. Thus, the use of such materials to manufacture gratings and grating-fillings in a single step may be limited, since the grating features may need to have high definition, for example, in the 100-500 nm range.

According to certain embodiments, the thickness and feature retention limitation of the SnO(n)Cl(m) coatings can be addressed by incorporating certain solvents and metal-oxide nanoparticles having engineered particle surfaces into the sol-gel precursor. For example, the metal oxide nanoparticles may have a core including TiO₂, Nb₂O₅, Ta₂O₅, ZrO₂, HfO₂, SnO₂, SnO, ZnS, ZnO, SiO₂, Al₂O₃, or BaTiO₃. The metal oxide nanoparticles may include a passivating metal oxide shell of ZrO₂, HfO₂, ZnS, SiO₂, Al₂O₃, ZnO, or Ta₂O₅. In some embodiments, the surfaces of the metal oxide nanoparticles may be passivated with phosphate, siloxane, or silicate species. In some embodiments, the surfaces of the metal oxide nanoparticles may be treated with organic species that have a low Sn-coordination strength and can prevent aggregation. In some embodiments, the surfaces of the metal oxide nanoparticles may be treated with methacrylate or acrylate-containing species. The nanoparticle suspension can be mixed with solutions containing tin dichloride and an alcohol-containing solvent or solvent mixture, and optionally an acrylate or methacrylate monomer or oligomer, an acrylate or methacrylate cross-linker, a photo-sensitizer such as a photo-acid generator, a photo-base generator, a photo-redox agent, or a radical-initiator.

As used herein, visible light may refer to light with a wavelength between about 380 nm and about 750 nm, between about 400 nm and about 700 nm, or between about 440 nm and about 650 nm. Near-infrared (NIR) light may refer to light with a wavelength between about 750 nm to about 2500 nm. The desired infrared (IR) wavelength range may refer to the wavelength range of IR light that can be detected by a suitable IR sensor (e.g., a complementary metal-oxide semiconductor (CMOS), a charge-coupled device (CCD) sensor, or an InGaAs sensor), such as between 830 nm and 860 nm, between 930 nm and 980 nm, or between about 750 nm to about 1000 nm.

As also used herein, a substrate may refer to a medium within which light may propagate. The substrate may include one or more types of dielectric materials, such as glass, quartz, plastic, polymer, poly(methyl methacrylate) (PMMA), crystal, or ceramic. At least one type of material of the substrate may be transparent to visible light and NIR light. The thickness of the substrate may range from, for example, less than about 1 mm to about 10 mm or more. As used herein, a material may be “transparent” to a light beam if the light beam can pass through the material with a high transmission rate, such as larger than 60%, 75%, 80%, 90%, 95%, 98%, 99%, or higher, where a small portion of the light beam (e.g., less than 40%, 25%, 20%, 10%, 5%, 2%, 1%, or less) may be scattered, reflected, or absorbed by the material. The transmission rate (i.e., transmissivity) may be represented by either a photopically weighted or an unweighted average transmission rate over a range of wavelengths, or the lowest transmission rate over a range of wavelengths, such as the visible wavelength range.

As also used herein, the term “support matrix” refers to the material, medium, substance, etc., in which the polymerizable component is dissolved, dispersed, embedded, enclosed, etc. In some embodiments, the support matrix is typically a low T_{g} polymer. The polymer may be organic, inorganic, or a mixture of the two. Without being particularly limited, the polymer may be a thermoset or thermoplastic.

As also used herein, the term “free radical polymerization” refers to any polymerization reaction that is initiated by any molecule comprising a free radical or radicals.

As also used herein, the term “cationic polymerization” refers to any polymerization reaction that is initiated by any molecule comprising a cationic moiety or moieties.

As also used herein, the term “anionic polymerization” refers to any polymerization reaction that is initiated by any molecule comprising an anionic moiety or moieties.

As also used herein, the term “photoinitiator” refers to the conventional meaning of the term photoinitiator and also refers to sensitizers and dyes. In general, a photoinitiator causes the light-initiated polymerization of a material, such as a photoactive oligomer or monomer, when the material containing the photoinitiator is exposed to light of a wavelength that activates the photoinitiator, e.g., a photoinitiating light source. The photoinitiator may refer to a combination of components, some of which individually are not light sensitive, yet in combination are capable of curing the photoactive oligomer or monomer, examples of which include a dye/amine, a sensitizer/iodonium salt, a dye/borate salt, and the like.

As also used herein, the term “polymerizable component” refers to one or more photoactive polymerizable materials, and possibly one or more additional polymerizable materials, e.g., monomers and/or oligomers, that are capable of forming a polymer.

As also used herein, the term “photoactive polymerizable material” refers to a monomer, an oligomer and combinations thereof that polymerize in the presence of a photoinitiator that has been activated by being exposed to a photoinitiating light source, e.g., recording light. In reference to the functional group that undergoes curing, the photoactive polymerizable material comprises at least one such functional group. It is also understood that there exist photoactive polymerizable materials that are also photoinitiators, such as N-methylmaleimide, derivatized acetophenones, etc., and that in such a case, it is understood that the photoactive monomer and/or oligomer of the present disclosure may also be a photoinitiator.

As also used herein, the term “photopolymer” refers to a polymer formed by one or more photoactive polymerizable materials, and possibly one or more additional monomers and/or oligomers.

As also used herein, the term “polymerization inhibitor” refers to one or more compositions, compounds, molecules, etc., that are capable of inhibiting or substantially inhibiting the polymerization of the polymerizable component when the photoinitiating light source is on or off. Polymerization inhibitors typically react very quickly with radicals and effectively stop a polymerization reaction. Inhibitors cause an inhibition time during which little to no photopolymer forms, e.g., only very small chains. Typically, photopolymerization occurs only after nearly 100% of the inhibitor is reacted.

As also used herein, the term “chain transfer agent” refers to one or more compositions, compounds, molecules, etc. that are capable of interrupting the growth of a polymeric molecular chain by formation of a new radical that may react as a new nucleus for forming a new polymeric molecular chain. Typically, chain transfer agents cause the formation of a higher proportion of shorter polymer chains, relative to polymerization reactions that occur in the absence of chain transfer agents. In some embodiments, certain chain transfer agents can behave as retarders or inhibitors if they do not efficiently reinitiate polymerization.

As also used herein, the terms “photo-acid generators,” “photo-base generators,” and “photogenerated radicals,” refer to one or more compositions, compounds, molecules, etc., that, when exposed to a light source, generate one or more compositions, compounds, molecules, etc., that are acidic, basic, or a free radical.

As also used herein, the term “alkyl” refers to a straight or branched hydrocarbon chain radical consisting solely of carbon and hydrogen atoms, containing no unsaturation, having from one to ten carbon atoms (e.g., (C₁₋₁₀)alkyl or C₁₋₁₀ alkyl). Whenever it appears herein, a numerical range such as “1 to 10” refers to each integer in the given range—e.g., “1 to 10 carbon atoms” means that the alkyl group may consist of 1 carbon atom, 2 carbon atoms, 3 carbon atoms, etc., up to and including 10 carbon atoms, although the definition is also intended to cover the occurrence of the term “alkyl” where no numerical range is specifically designated. Typical alkyl groups include, but are in no way limited to, methyl, ethyl, propyl, isopropyl, n-butyl, isobutyl, sec-butyl isobutyl, tertiary butyl, pentyl, isopentyl, neopentyl, hexyl, septyl, octyl, nonyl and decyl. The alkyl moiety may be attached to the rest of the molecule by a single bond, such as for example, methyl (Me), ethyl (Et), n-propyl (Pr), 1-methylethyl (isopropyl), n-butyl, n-pentyl, 1,1-dimethylethyl (t-butyl) and 3-methylhexyl. Unless stated otherwise specifically in the specification, an alkyl group is optionally substituted by one or more of substituents which are independently heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂ where each R^{a} is independently hydrogen, fluoroalkyl, carbocyclyl, carbocyclylalkyl, aryl, aralkyl, heterocycloalkyl, heterocycloalkylalkyl, heteroaryl or heteroarylalkyl.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

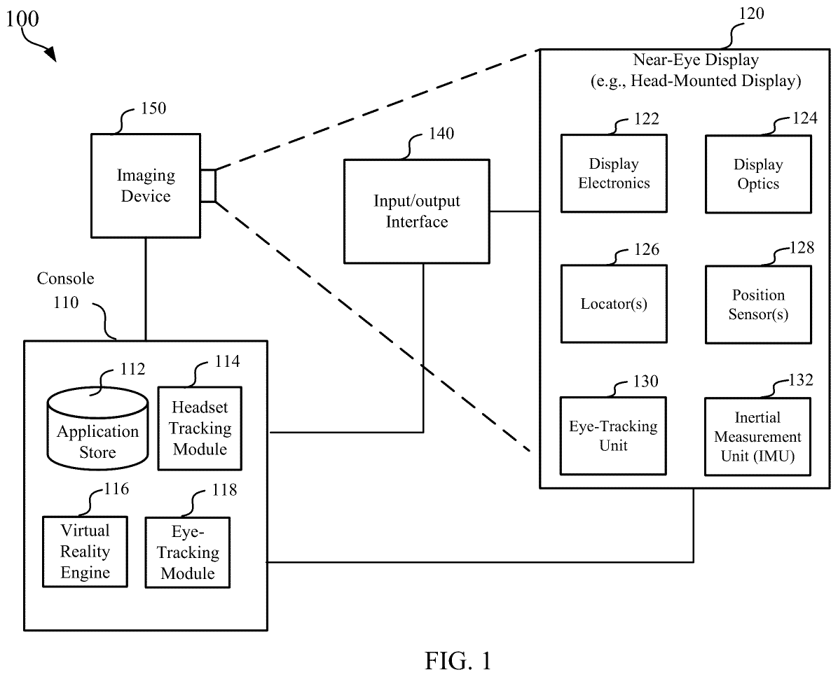

FIG. 1 is a simplified block diagram of an example of an artificial reality system environment 100 including a near-eye display system 120 in accordance with certain embodiments. Artificial reality system environment 100 shown in FIG. 1 may include near-eye display system 120, an optional imaging device 150, and an optional input/output interface 140 that may each be coupled to an optional console 110. While FIG. 1 shows example artificial reality system environment 100 including one near-eye display system 120, one imaging device 150, and one input/output interface 140, any number of these components may be included in artificial reality system environment 100, or any of the components may be omitted. For example, there may be multiple near-eye display systems 120 monitored by one or more external imaging devices 150 in communication with console 110. In some configurations, artificial reality system environment 100 may not include imaging device 150, optional input/output interface 140, and optional console 110. In alternative configurations, different or additional components may be included in artificial reality system environment 100. In some configurations, near-eye display systems 120 may include imaging device 150, which may be used to track one or more input/output devices (e.g., input/output interface 140), such as a handhold controller.

Near-eye display system 120 may be a head-mounted display that presents content to a user. Examples of content presented by near-eye display system 120 include one or more of images, videos, audios, or some combination thereof. In some embodiments, audios may be presented via an external device (e.g., speakers and/or headphones) that receives audio information from near-eye display system 120, console 110, or both, and presents audio data based on the audio information. Near-eye display system 120 may include one or more rigid bodies, which may be rigidly or non-rigidly coupled to each other. A rigid coupling between rigid bodies may cause the coupled rigid bodies to function as a single rigid entity. A non-rigid coupling between rigid bodies may allow the rigid bodies to move relative to each other. In various embodiments, near-eye display system 120 may be implemented in any suitable form factor, including a pair of glasses. Some embodiments of near-eye display system 120 are further described below. Additionally, in various embodiments, the functionality described herein may be used in a headset that combines images of an environment external to near-eye display system 120 and artificial reality content (e.g., computer-generated images). Therefore, near-eye display system 120 may augment images of a physical, real-world environment external to near-eye display system 120 with generated content (e.g., images, video, sound, etc.) to present an augmented reality to a user.

In various embodiments, near-eye display system 120 may include one or more of display electronics 122, display optics 124, and an eye-tracking system 130. In some embodiments, near-eye display system 120 may also include one or more locators 126, one or more position sensors 128, and an inertial measurement unit (IMU) 132. Near-eye display system 120 may omit any of these elements or include additional elements in various embodiments. Additionally, in some embodiments, near-eye display system 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display system 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereo effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers), magnify image light received from display electronics 122, correct optical errors associated with the image light, and present the corrected image light to a user of near-eye display system 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an anti-reflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display system 120/

Display optics 124 may also be designed to correct one or more types of optical errors, such as two-dimensional optical errors, three-dimensional optical errors, or a combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display system 120 relative to one another and relative to a reference point on near-eye display system 120. In some implementations, console 110 may identify locators 126 in images captured by imaging device 150 to determine the artificial reality headset's position, orientation, or both. A locator 126 may be a light emitting diode (LED), a corner cube reflector, a reflective marker, a type of light source that contrasts with an environment in which near-eye display system 120 operates, or some combinations thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

Imaging device 150 may be part of near-eye display system 120 or may be external to near-eye display system 120. Imaging device 150 may generate slow calibration data based on calibration parameters received from console 110. Slow calibration data may include one or more images showing observed positions of locators 126 that are detectable by imaging device 150. Imaging device 150 may include one or more cameras, one or more video cameras, any other device capable of capturing images including one or more of locators 126, or some combinations thereof. Additionally, imaging device 150 may include one or more filters (e.g., to increase signal to noise ratio). Imaging device 150 may be configured to detect light emitted or reflected from locators 126 in a field of view of imaging device 150. In embodiments where locators 126 include passive elements (e.g., retroreflectors), imaging device 150 may include a light source that illuminates some or all of locators 126, which may retro-reflect the light to the light source in imaging device 150. Slow calibration data may be communicated from imaging device 150 to console 110, and imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display system 120. Examples of position sensors 128 may include accelerometers, gyroscopes, magnetometers, other motion-detecting or error-correcting sensors, or some combinations thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or some combination thereof. Based on the one or more measurement signals from one or more position sensors 128, IMU 132 may generate fast calibration data indicating an estimated position of near-eye display system 120 relative to an initial position of near-eye display system 120. For example, IMU 132 may integrate measurement signals received from accelerometers over time to estimate a velocity vector and integrate the velocity vector over time to determine an estimated position of a reference point on near-eye display system 120. Alternatively, IMU 132 may provide the sampled measurement signals to console 110, which may determine the fast calibration data. While the reference point may generally be defined as a point in space, in various embodiments, the reference point may also be defined as a point within near-eye display system 120 (e.g., a center of IMU 132).

Eye-tracking system 130 may include one or more eye-tracking systems. Eye tracking may refer to determining an eye's position, including orientation and location of the eye, relative to near-eye display system 120. An eye-tracking system may include an imaging system to image one or more eyes and may generally include a light emitter, which may generate light that is directed to an eye such that light reflected by the eye may be captured by the imaging system. For example, eye-tracking system 130 may include a non-coherent or coherent light source (e.g., a laser diode) emitting light in the visible spectrum or infrared spectrum, and a camera capturing the light reflected by the user's eye. As another example, eye-tracking system 130 may capture reflected radio waves emitted by a miniature radar unit. Eye-tracking system 130 may use low-power light emitters that emit light at frequencies and intensities that would not injure the eye or cause physical discomfort. Eye-tracking system 130 may be arranged to increase contrast in images of an eye captured by eye-tracking system 130 while reducing the overall power consumed by eye-tracking system 130 (e.g., reducing power consumed by a light emitter and an imaging system included in eye-tracking system 130). For example, in some implementations, eye-tracking system 130 may consume less than 100 milliwatts of power.

Eye-tracking system 130 may be configured to estimate the orientation of the user's eye. The orientation of the eye may correspond to the direction of the user's gaze within near-eye display system 120. The orientation of the user's eye may be defined as the direction of the foveal axis, which is the axis between the fovea (an area on the retina of the eye with the highest concentration of photoreceptors) and the center of the eye's pupil. In general, when a user's eyes are fixed on a point, the foveal axes of the user's eyes intersect that point. The pupillary axis of an eye may be defined as the axis that passes through the center of the pupil and is perpendicular to the corneal surface. In general, even though the pupillary axis and the foveal axis intersect at the center of the pupil, the pupillary axis may not directly align with the foveal axis. For example, the orientation of the foveal axis may be offset from the pupillary axis by approximately −1° to 8° laterally and about ±4° vertically (which may be referred to as kappa angles, which may vary from person to person). Because the foveal axis is defined according to the fovea, which is located in the back of the eye, the foveal axis may be difficult or impossible to measure directly in some eye-tracking embodiments. Accordingly, in some embodiments, the orientation of the pupillary axis may be detected and the foveal axis may be estimated based on the detected pupillary axis.

In general, the movement of an eye corresponds not only to an angular rotation of the eye, but also to a translation of the eye, a change in the torsion of the eye, and/or a change in the shape of the eye. Eye-tracking system 130 may also be configured to detect the translation of the eye, which may be a change in the position of the eye relative to the eye socket. In some embodiments, the translation of the eye may not be detected directly, but may be approximated based on a mapping from a detected angular orientation. Translation of the eye corresponding to a change in the eye's position relative to the eye-tracking system due to, for example, a shift in the position of near-eye display system 120 on a user's head, may also be detected. Eye-tracking system 130 may also detect the torsion of the eye and the rotation of the eye about the pupillary axis. Eye-tracking system 130 may use the detected torsion of the eye to estimate the orientation of the foveal axis from the pupillary axis. In some embodiments, eye-tracking system 130 may also track a change in the shape of the eye, which may be approximated as a skew or scaling linear transform or a twisting distortion (e.g., due to torsional deformation). In some embodiments, eye-tracking system 130 may estimate the foveal axis based on some combinations of the angular orientation of the pupillary axis, the translation of the eye, the torsion of the eye, and the current shape of the eye.

In some embodiments, eye-tracking system 130 may include multiple emitters or at least one emitter that can project a structured light pattern on all portions or a portion of the eye. The structured light pattern may be distorted due to the shape of the eye when viewed from an offset angle. Eye-tracking system 130 may also include at least one camera that may detect the distortions (if any) of the structured light pattern projected onto the eye. The camera may be oriented on a different axis to the eye than the emitter. By detecting the deformation of the structured light pattern on the surface of the eye, eye-tracking system 130 may determine the shape of the portion of the eye being illuminated by the structured light pattern. Therefore, the captured distorted light pattern may be indicative of the 3D shape of the illuminated portion of the eye. The orientation of the eye may thus be derived from the 3D shape of the illuminated portion of the eye. Eye-tracking system 130 can also estimate the pupillary axis, the translation of the eye, the torsion of the eye, and the current shape of the eye based on the image of the distorted structured light pattern captured by the camera.

Near-eye display system 120 may use the orientation of the eye to, e.g., determine an inter-pupillary distance (IPD) of the user, determine gaze directions, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or some combination thereof. Because the orientation may be determined for both eyes of the user, eye-tracking system 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, imaging device 150 may be used to track input/output interface 140, such as tracking the location or position of a controller (which may include, for example, an IR light source) or a hand of the user to determine the motion of the user. In some embodiments, near-eye display system 120 may include one or more imaging devices (e.g., imaging device 150) to track input/output interface 140, such as tracking the location or position of a controller or a hand of the user to determine the motion of the user.

Console 110 may provide content to near-eye display system 120 for presentation to the user in accordance with information received from one or more of imaging device 150, near-eye display system 120, and input/output interface 140. In the example shown in FIG. 1, console 110 may include an application store 112, a headset tracking module 114, an artificial reality engine 116, and eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display system 120 using slow calibration information from imaging device 150. For example, headset tracking module 114 may determine positions of a reference point of near-eye display system 120 using observed locators from the slow calibration information and a model of near-eye display system 120. Headset tracking module 114 may also determine positions of a reference point of near-eye display system 120 using position information from the fast calibration information. Additionally, in some embodiments, headset tracking module 114 may use portions of the fast calibration information, the slow calibration information, or some combination thereof, to predict a future location of near-eye display system 120. Headset tracking module 114 may provide the estimated or predicted future position of near-eye display system 120 to artificial reality engine 116.

Headset tracking module 114 may calibrate the artificial reality system environment 100 using one or more calibration parameters, and may adjust one or more calibration parameters to reduce errors in determining the position of near-eye display system 120. For example, headset tracking module 114 may adjust the focus of imaging device 150 to obtain a more accurate position for observed locators on near-eye display system 120. Moreover, calibration performed by headset tracking module 114 may also account for information received from IMU 132. Additionally, if tracking of near-eye display system 120 is lost (e.g., imaging device 150 loses line of sight of at least a threshold number of locators 126), headset tracking module 114 may re-calibrate some or all of the calibration parameters.

Artificial reality engine 116 may execute applications within artificial reality system environment 100 and receive position information of near-eye display system 120, acceleration information of near-eye display system 120, velocity information of near-eye display system 120, predicted future positions of near-eye display system 120, or some combination thereof from headset tracking module 114. Artificial reality engine 116 may also receive estimated eye position and orientation information from eye-tracking module 118. Based on the received information, artificial reality engine 116 may determine content to provide to near-eye display system 120 for presentation to the user. For example, if the received information indicates that the user has looked to the left, artificial reality engine 116 may generate content for near-eye display system 120 that reflects the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display system 120 or haptic feedback via input/output interface 140.

Eye-tracking module 118 may receive eye-tracking data from eye-tracking system 130 and determine the position of the user's eye based on the eye-tracking data. The position of the eye may include an eye's orientation, location, or both relative to near-eye display system 120 or any element thereof. Because the eye's axes of rotation change as a function of the eye's location in its socket, determining the eye's location in its socket may allow eye-tracking module 118 to more accurately determine the eye's orientation.

In some embodiments, eye-tracking module 118 may store a mapping between images captured by eye-tracking system 130 and eye positions to determine a reference eye position from an image captured by eye-tracking system 130. Alternatively or additionally, eye-tracking module 118 may determine an updated eye position relative to a reference eye position by comparing an image from which the reference eye position is determined to an image from which the updated eye position is to be determined. Eye-tracking module 118 may determine eye position using measurements from different imaging devices or other sensors. For example, eye-tracking module 118 may use measurements from a slow eye-tracking system to determine a reference eye position, and then determine updated positions relative to the reference eye position from a fast eye-tracking system until a next reference eye position is determined based on measurements from the slow eye-tracking system.

Eye-tracking module 118 may also determine eye calibration parameters to improve precision and accuracy of eye tracking. Eye calibration parameters may include parameters that may change whenever a user dons or adjusts near-eye display system 120. Example eye calibration parameters may include an estimated distance between a component of eye-tracking system 130 and one or more parts of the eye, such as the eye's center, pupil, cornea boundary, or a point on the surface of the eye. Other example eye calibration parameters may be specific to a particular user and may include an estimated average eye radius, an average corneal radius, an average sclera radius, a map of features on the eye surface, and an estimated eye surface contour. In embodiments where light from the outside of near-eye display system 120 may reach the eye (as in some augmented reality applications), the calibration parameters may include correction factors for intensity and color balance due to variations in light from the outside of near-eye display system 120. Eye-tracking module 118 may use eye calibration parameters to determine whether the measurements captured by eye-tracking system 130 would allow eye-tracking module 118 to determine an accurate eye position (also referred to herein as “valid measurements”). Invalid measurements, from which eye-tracking module 118 may not be able to determine an accurate eye position, may be caused by the user blinking, adjusting the headset, or removing the headset, and/or may be caused by near-eye display system 120 experiencing greater than a threshold change in illumination due to external light. In some embodiments, at least some of the functions of eye-tracking module 118 may be performed by eye-tracking system 130.

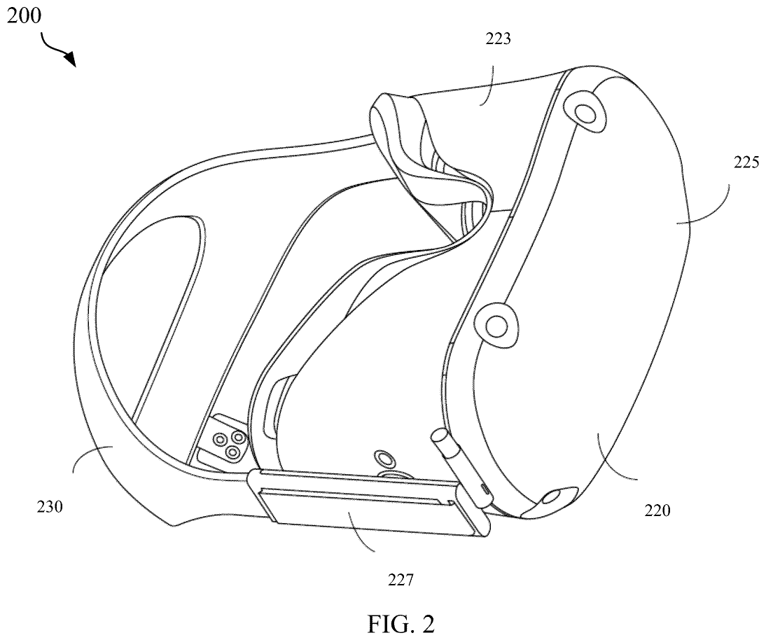

FIG. 2 is a perspective view of an example of a near-eye display system in the form of a head-mounted display (HMD) device 200 for implementing some of the examples disclosed herein. HMD device 200 may be a part of, e.g., a virtual reality (VR) system, an augmented reality (AR) system, a mixed reality (MR) system, or some combinations thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temples tips as shown in, for example, FIG. 2, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audios, or some combinations thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, a liquid crystal display (LCD), an organic light emitting diode (OLED) display, an inorganic light emitting diode (ILED) display, a micro light emitting diode (μLED) display, an active-matrix organic light emitting diode (AMOLED) display, a transparent organic light emitting diode (TOLED) display, some other display, or some combinations thereof. HMD device 200 may include two eye box regions.

In some implementations, HMD device 200 may include various sensors (not shown), such as depth sensors, motion sensors, position sensors, and eye-tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or some combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

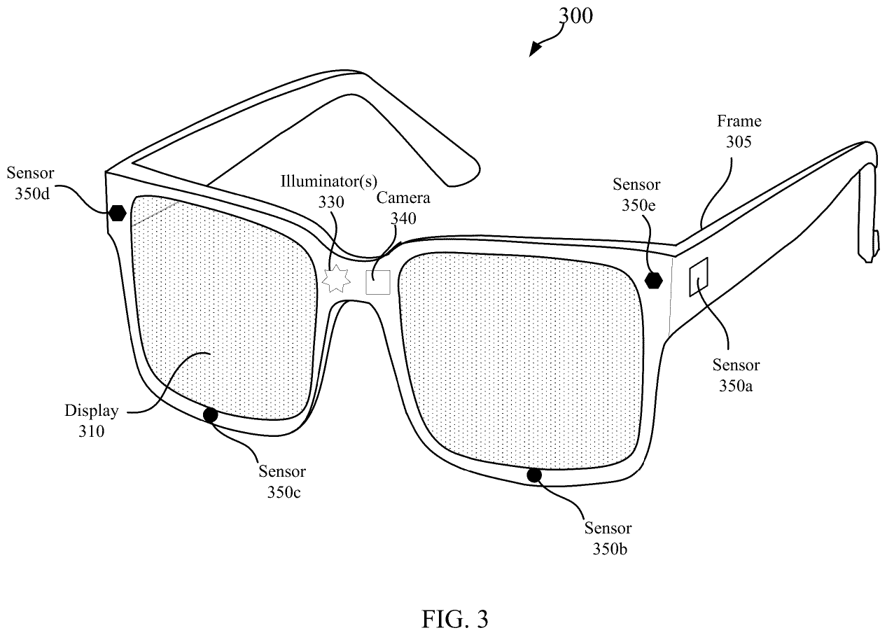

FIG. 3 is a perspective view of an example of a near-eye display system 300 in the form of a pair of glasses for implementing some of the examples disclosed herein. Near-eye display system 300 may be a specific implementation of near-eye display system 120 of FIG. 1, and may be configured to operate as a virtual reality display, an augmented reality display, and/or a mixed reality display. Near-eye display system 300 may include a frame 305 and a display 310. Display 310 may be configured to present content to a user. In some embodiments, display 310 may include display electronics and/or display optics. For example, as described above with respect to near-eye display system 120 of FIG. 1, display 310 may include an LCD display panel, an LED display panel, or an optical display panel (e.g., a waveguide display assembly).

Near-eye display system 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display system 300, and/or to provide an interactive VR/AR/MR experience to a user of near-eye display system 300. In some embodiments, sensors 350a-350e may also be used for stereoscopic imaging.

In some embodiments, near-eye display system 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light pattern onto the objects within the environment. In some embodiments, illuminator(s) 330 may be used as locators, such as locators 126 described above with respect to FIG. 1.

In some embodiments, near-eye display system 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

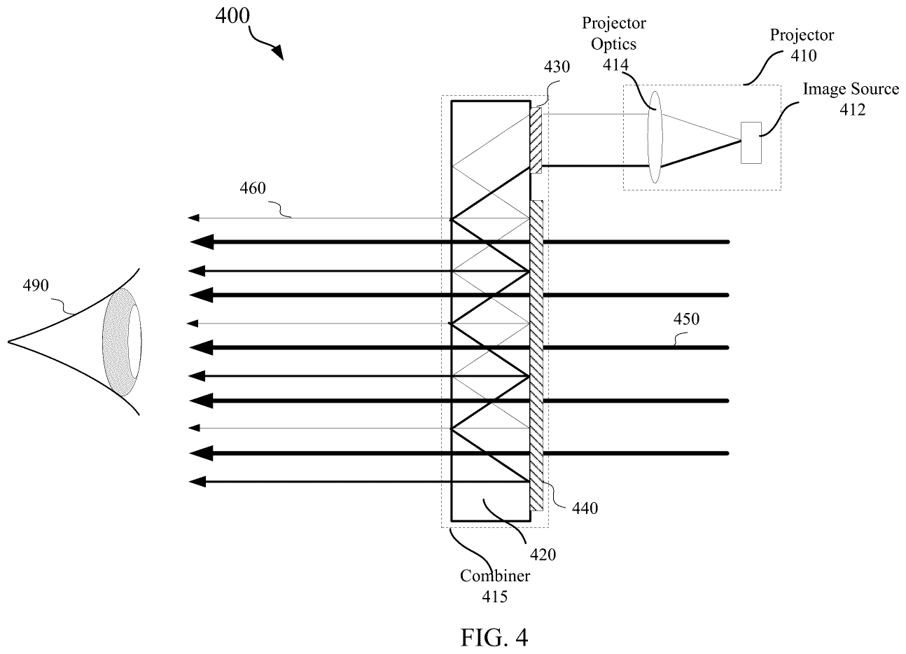

FIG. 4 illustrates an example of an optical see-through augmented reality system 400 using a waveguide display according to certain embodiments. Augmented reality system 400 may include a projector 410 and a combiner 415. Projector 410 may include a light source or image source 412 and projector optics 414. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, and/or a light emitting diode. In some embodiments, image source 412 may include a plurality of light sources each emitting a monochromatic image light corresponding to a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Input coupler 430 may include a volume holographic grating, a diffractive optical elements (DOE) (e.g., a surface-relief grating), a slanted surface of substrate 420, or a refractive coupler (e.g., a wedge or a prism). Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more. Substrate 420 may be transparent to visible light.

Substrate 420 may include or may be coupled to a plurality of output couplers 440 configured to extract at least a portion of the light guided by and propagating within substrate 420 from substrate 420, and direct extracted light 460 to an eye 490 of the user of augmented reality system 400. As input coupler 430, output couplers 440 may include grating couplers (e.g., volume holographic gratings or surface-relief gratings), other DOEs, prisms, etc. Output couplers 440 may have different coupling (e.g., diffraction) efficiencies at different locations. Substrate 420 may also allow light 450 from environment in front of combiner 415 to pass through with little or no loss. Output couplers 440 may also allow light 450 to pass through with little loss. For example, in some implementations, output couplers 440 may have a low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 to certain desired directions (i.e., diffraction angles) with little loss. As a result, the user may be able to view combined images of the environment in front of combiner 415 and virtual objects projected by projector 410.

In addition, as described above, in an artificial reality system, to improve user interaction with presented content, the artificial reality system may track the user's eye and modify or generate content based on a location or a direction in which the user is looking at. Tracking the eye may include tracking the position and/or shape of the pupil and/or the cornea of the eye, and determining the rotational position or gaze direction of the eye. One technique (referred to as Pupil Center Corneal Reflection or PCCR method) involves using NIR LEDs to produce glints on the eye cornea surface and then capturing images/videos of the eye region. Gaze direction can be estimated from the relative movement between the pupil center and glints. Various holographic optical elements may be used in an eye-tracking system for illuminating the user's eyes or collecting light reflected by the user's eye.

One example of the holographic optical elements used in an artificial reality system for eye tracking or image display may be a holographic volume Bragg grating, which may be recorded on a holographic material layer by exposing the holographic material layer to light patterns generated by the interference between two or more coherent light beams.

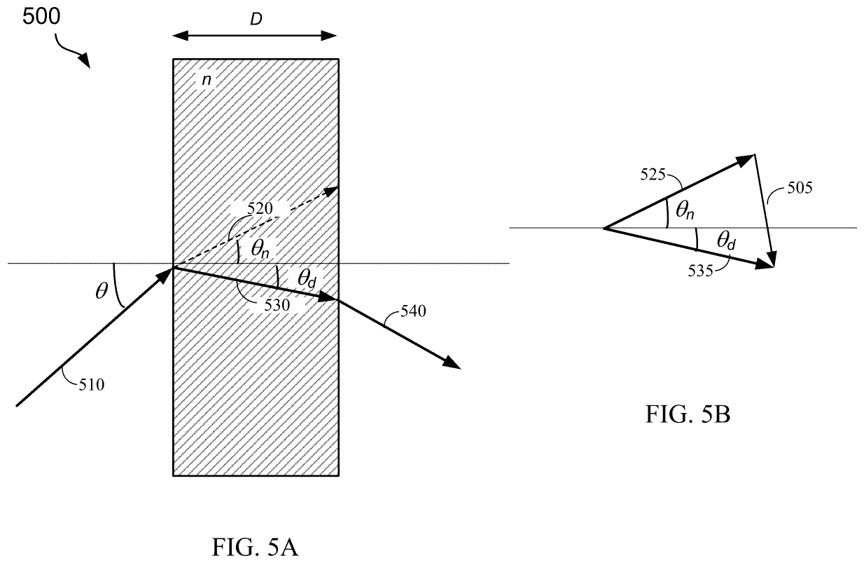

FIG. 5A illustrates an example of a volume Bragg grating (VBG) 500. Volume Bragg grating 500 shown in FIG. 5A may include a transmission holographic grating that has a thickness D. The refractive index n of volume Bragg grating 500 may be modulated at an amplitude n₁, and the grating period of volume Bragg grating 500 may be Λ. Incident light 510 having a wavelength λ may be incident on volume Bragg grating 500 at an incident angle θ, and may be refracted into volume Bragg grating 500 as incident light 520 that propagates at an angle θₙ in volume Bragg grating 500. Incident light 520 may be diffracted by volume Bragg grating 500 into diffraction light 530, which may propagate at a diffraction angle θ_{d} in volume Bragg grating 500 and may be refracted out of volume Bragg grating 500 as diffraction light 540.

FIG. 5B illustrates the Bragg condition for volume Bragg grating 500 shown in FIG. 5A. Vector 505 represents the grating vector \vec{G}, where |\vec{G}|=2π/Λ. Vector 525 represents the incident wave vector \vec{kᵢ}, and vector 535 represents the diffract wave vector \vec{k_{d}}, where |\vec{kᵢ}|=|\vec{k_{d}}|=2πn/λ. Under the Bragg phase-matching condition, \vec{kᵢ}−\vec{k_{d}}=\vec{G}. Thus, for a given wavelength λ, there may only be one pair of incident angle θ (or θₙ) and diffraction angle θ_{d} that meets the Bragg condition perfectly. Similarly, for a given incident angle θ, there may only be one wavelength λ that meets the Bragg condition perfectly. As such, the diffraction may only occur in a small wavelength range and a small incident angle range. The diffraction efficiency, the wavelength selectivity, and the angular selectivity of volume Bragg grating 500 may be functions of thickness D of volume Bragg grating 500. For example, the full-width-half-magnitude (FWHM) wavelength range and the FWHM angle range of volume Bragg grating 500 at the Bragg condition may be inversely proportional to thickness D of volume Bragg grating 500, while the maximum diffraction efficiency at the Bragg condition may be a function sin²(a×n₁×D), where a is a coefficient. For a reflection volume Bragg grating, the maximum diffraction efficiency at the Bragg condition may be a function of tan h²(a×n₁×D).

In some embodiments, a multiplexed Bragg grating may be used to achieve the desired optical performance, such as a high diffraction efficiency and a large FOV for the full visible spectrum (e.g., from about 400 nm to about 700 nm, or from about 440 nm to about 650 nm). Each part of the multiplexed Bragg grating may be used to diffract light from a respective FOV range and/or within a respective wavelength range. Thus, in some designs, multiple volume Bragg gratings each recorded under a respective recording condition may be used.

The holographic optical elements described above may be recorded in a holographic material (e.g., photopolymer) layer. In some embodiments, the HOEs can be recorded first and then laminated on a substrate in a near-eye display system. In some embodiments, a holographic material layer may be coated or laminated on the substrate and the HOEs may then be recorded in the holographic material layer.

In general, to record a holographic optical element in a photosensitive material layer, two coherent beams may interfere with each other at certain angles to generate a unique interference pattern in the photosensitive material layer, which may in turn generate a unique refractive index modulation pattern in the photosensitive material layer, where the refractive index modulation pattern may correspond to the light intensity pattern of the interference pattern. The photosensitive material layer may include, for example, silver halide emulsion, dichromated gelatin, photopolymers including photo-polymerizable monomers suspended in a polymer matrix, photorefractive crystals, and the like. One example of the photosensitive material layer for holographic recording is two-stage photopolymers.

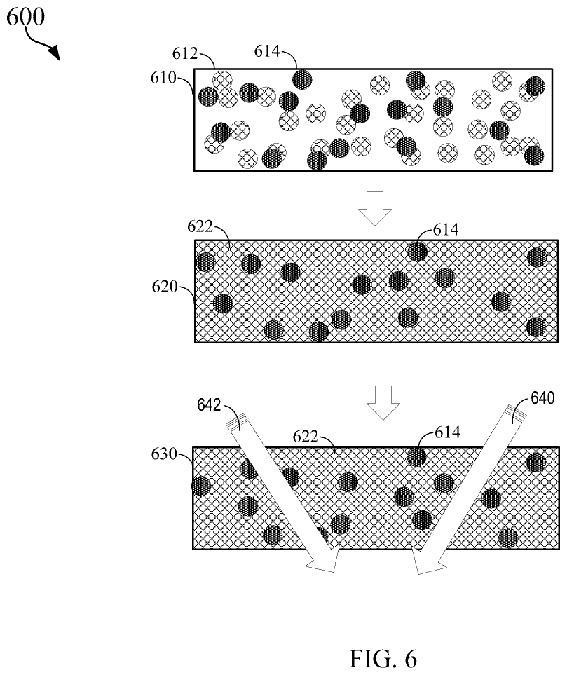

FIG. 6 includes a diagram 600 illustrating an example of a holographic recording material including two-stage photopolymers. The raw material 610 of the two-stage photopolymers may be a resin including matrix precursors 612 and imaging components 614. Matrix precursors 612 in raw material 610 may include monomers that may be thermally or otherwise cured at the first stage to polymerize and to form a photopolymer film 620 that includes a cross-linked matrix formed by polymeric binders 622. Imaging components 614 may include writing monomers and polymerization initiating agents, such as photosensitizing dyes, initiators, and/or chain transfer agents. Thus, photopolymer film 620 may include polymeric binders 622, writing monomers (e.g., acrylate monomers), and initiating agents, such as photosensitizing dyes, initiators, and/or chain transfer agents. Polymeric binders 622 may function as the backbone or the support matrix for the writing monomers and initiating agents. For example, in some embodiments, polymeric binders 622 may include a low refractive index (e.g., <1.5) rubbery polymer (e.g., a polyurethane), which may provide mechanical support during the holographic exposure and ensure the refractive index modulation by the light pattern is permanently preserved.

Imaging components 614 including the writing monomers and the polymerization initiating agents may be dispersed in the support matrix. The writing monomers may serve as refractive index modulators. For example, the writing monomers may include high refractive index acrylate monomers which can react with the initiators and polymerize. The photosensitizing dyes may be used to absorb light and interact with the initiators to produce active species, such as radicals, cations (e.g., acids), or anion (e.g., bases). The active species (e.g., radicals) may initiate the polymerization by attacking a monomer. For example, in some monomers, one electron pair may be held securely between two carbons in a sigma bond and another electron pair may be more loosely held in a pi bond, and the free radical may use one electron from the pi bond to form a more stable bond with a first carbon atom in the two carbon atoms. The other electron from the pi bond may return to the second carbon atom in the two carbon atoms and turn the whole molecule into another radical. Thus, a monomer chain (e.g., a polymer) may be formed by adding additional monomers to the end of the monomer chain and transferring the radical to the end of the monomer chain to attack and add more monomers to the chain.

During the recording process (e.g., the second stage), an interference pattern generated by the interference between two coherent beams 640 and 642 may cause the photosensitizing dyes and the initiators in the bright fringes to generate active species, such as radicals, cations (e.g., acids), or anion (e.g., bases), from the initiators, where the active species (e.g., radicals) may transfer from the initiators to monomers and cause the polymerization of the monomers in the bright fringes as described above. The initiators or radicals may be bound to the polymer matrix when abstracting the hydrogen atoms on the polymer matrix. The radicals may be transferred to the ends of the chains of monomers to add more monomers to the chains. While the monomers in the bright fringes are attached to chains of monomers, monomers in the unexposed dark regions may diffuse to the bright fringes to enhance the polymerization. As a result, polymerization concentration and density gradients may be formed in photopolymer film 620, resulting in refractive index modulation in photopolymer film 620 due to the higher refractive index of the writing monomers. For example, areas with a higher concentration of monomers and polymerization may have a higher refractive index. Thus, a hologram or a holographic optical element 630 may be formed in photopolymer film 620.

During the exposure, a radical at the end of one monomer chain may combine with a radical at the end of another monomer chain to form a longer chain and terminate the polymerization. In addition to the termination due to radical combination, the polymerization may also be terminated by disproportionation of polymers, where a hydrogen atom from one chain may be abstracted to another chain to generate a polymer with a terminal unsaturated group and a polymer with a terminal saturated group. The polymerization may also be terminated due to interactions with impurities or inhibitors (e.g., oxygen). In addition, as the exposure and polymerization proceed, fewer monomers may be available for diffusion and polymerization, and thus the diffusion and polymerization may be suppressed. The polymerization may stop until there are no more monomers or until the monomer chains terminate for an exposure. After all or substantially all monomers have been polymerized, no more new holographic optical elements 630 (e.g., gratings) may be recorded in photopolymer film 620.

In some embodiments, the recorded holographic optical elements in the photosensitive material layer may be UV cured or thermally cured or enhanced, for example, for dye bleaching, completing polymerization, permanently fixing the recorded pattern, and enhancing the refractive index modulation. At the end of the process, a holographic optical element, such as a holographic grating, may be formed. The holographic grating may be a volume Bragg grating with a thickness of, for example, a few, or tens, or hundreds of microns.

To generate the desired light interference pattern for recording the HOEs, two or more coherent beams may generally be used, where one beam may be a reference beam and another beam may be an object beam that may have a desired wavefront profile. When the recorded HOEs are illuminated by the reference beam, the object beam with the desired wavefront profile may be reconstructed.

In some embodiments, the holographic optical elements may be used to diffract light outside of the visible band. For example, IR light or NIR light (e.g., at 940 nm or 850 nm) may be used for eye-tracking. Thus, the holographic optical elements may need to diffract IR or NIR light, but not the visible light. However, there may be very few holographic recording materials that are sensitive to infrared light. As such, to record a holographic grating that can diffract infrared light, recording light at a shorter wavelength (e.g., in visible or UV band, such as at about 660 nm, about 532 nm, about 514 nm, or about 457 nm) may be used, and the recording condition (e.g., the angles of the two interfering coherent beams) may be different from the reconstruction condition.

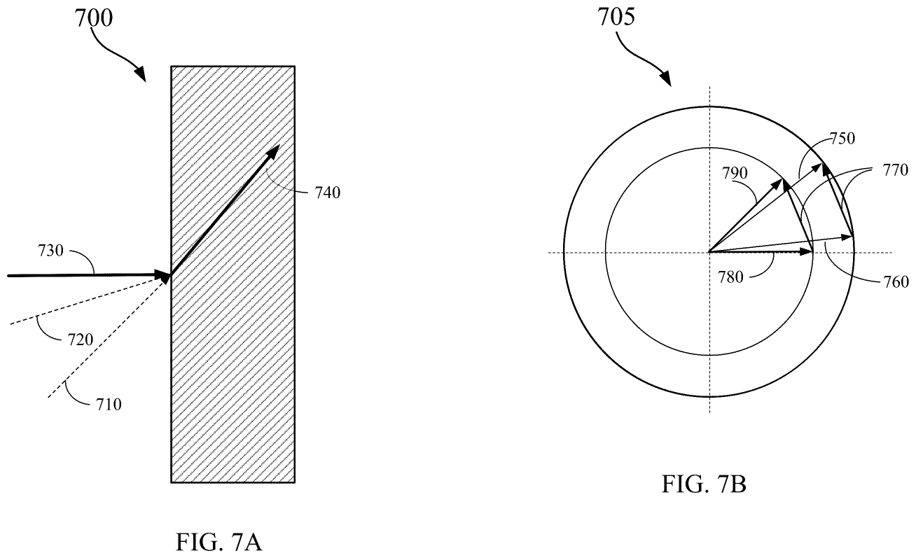

FIG. 7A illustrates the recording light beams for recording a volume Bragg grating 700 and the light beam reconstructed from volume Bragg grating 700. In the example illustrated, volume Bragg grating 700 may include a transmission volume hologram recorded using a reference beam 720 and an object beam 710 at a first wavelength, such as 660 nm. When a light beam 730 at a second wavelength (e.g., 940 nm) is incident on volume Bragg grating 700 at a 0° incident angle, the incident light beam 730 may be diffracted by volume Bragg grating 700 at a diffraction angle as shown by a diffracted beam 740.

FIG. 7B is an example of a holography momentum diagram 705 illustrating the wave vectors of recording beams and reconstruction beams and the grating vector of the recorded volume Bragg grating. FIG. 7B shows the Bragg matching conditions during the holographic grating recording and reconstruction. The length of wave vectors 750 and 760 of the recording beams (e.g., object beam 710 and reference beam 720) may be determined based on the recording light wavelength λ_{c} (e.g., 660 nm) according to 2πn/λ_{c}, where n is the average refractive index of holographic material layer. The directions of wave vectors 750 and 760 of the recording beams may be determined based on the desired grating vector K (770) such that wave vectors 750 and 760 and grating vector K (770) can form an isosceles triangle as shown in FIG. 7B. Grating vector K may have an amplitude 2π/Λ, where Λ is the grating period. Grating vector K may in turn be determined based on the desired reconstruction condition. For example, based on the desired reconstruction wavelength λᵣ (e.g., 940 nm) and the directions of the incident light beam (e.g., light beam 730 at 0°) and the desired diffracted light beam (e.g., diffracted beam 740), grating vector K (770) of volume Bragg grating 700 may be determined based on the Bragg condition, where wave vector 780 of the incident light beam (e.g., light beam 730) and wave vector 790 of the diffracted light beam (e.g., diffracted beam 740) may have an amplitude 2πn/λᵣ, and may form an isosceles triangle with grating vector K (770) as shown in FIG. 7B.

As described above, for a given wavelength, there may only be one pair of incident angle and diffraction angle that meets the Bragg condition perfectly. Similarly, for a given incident angle, there may only be one wavelength that meets the Bragg condition perfectly. When the incident angle of the reconstruction light beam is different from the incident angle that meets the Bragg condition of the volume Bragg grating or when the wavelength of the reconstruction light beam is different from the wavelength that meets the Bragg condition of the volume Bragg grating, the diffraction efficiency may be reduced as a function of the Bragg mismatch factor caused by the angular or wavelength detuning from the Bragg condition. As such, the diffraction may only occur in a small wavelength range and a small incident angle range.

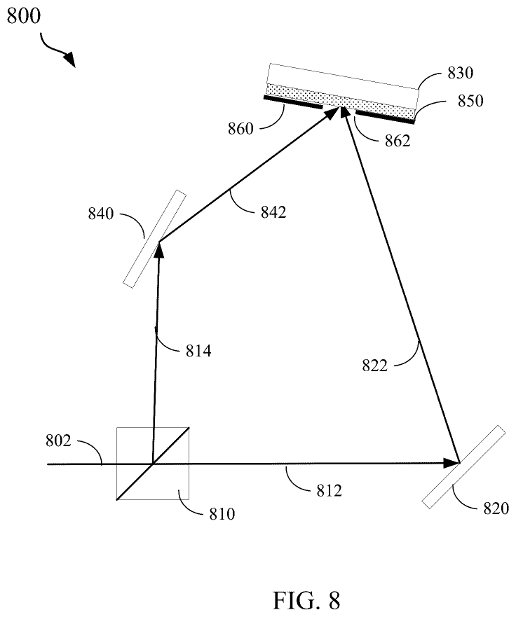

FIG. 8 illustrates an example of a holographic recording system 800 for recording holographic optical elements. Holographic recording system 800 includes a beam splitter 810 (e.g., a beam splitter cube), which may split an incident collimated laser beam 802 into two light beams 812 and 814 that are coherent and have similar intensities. Light beam 812 may be reflected by a first mirror 820 towards a plate 830 as shown by the reflected light beam 822. On another path, light beam 814 may be reflected by a second mirror 840. The reflected light beam 842 may be directed towards plate 830, and may interfere with light beam 822 at plate 830 to generate an interference pattern that may include bright fringes and dark fringes. In some embodiments, plate 830 may also be a mirror. A holographic recording material layer 850 may be formed on plate 830 or on a substrate mounted on plate 830. The interference pattern may cause the holographic optical element to be recorded in holographic recording material layer 850 as described above.

In some embodiments, a mask 860 may be used to record different HOEs at different regions of holographic recording material layer 850. For example, mask 860 may include an aperture 862 for the holographic recording and may be moved to place aperture 862 at different regions on holographic recording material layer 850 to record different HOEs at the different regions under different recording conditions (e.g., recording beams with different angles).

Holographic recording materials can be selected for specific applications based on some parameters of the holographic recording materials, such as the spatial frequency response, dynamic range, photosensitivity, physical dimensions, mechanical properties, wavelength sensitivity, and development or bleaching method for the holographic recording material.

The dynamic range indicates the refractive index change that can be achieved in a holographic recording material. The dynamic range may affect, for example, the thickness of the device to achieve a high efficiency, and the number of holograms that can be multiplexed in a holographic material layer. The dynamic range may be represented by the refractive index modulation (RIM), which may be one half of the total change in refractive index. In generally, a large refractive index modulation in the holographic optical elements is desired in order to improve the diffraction efficiency and record multiple holographic optical elements in a same holographic material layer. However, for holographic photopolymer materials, due to the solubility limitation of the monomers in the holographic photopolymer materials, the maximum achievable refractive index modulation or dynamic range may be limited.

The spatial frequency response is a measure of the feature size that the holographic material can record and may dictate the types of Bragg conditions that can be achieved. The spatial frequency response can be characterized by a modulation transfer function, which may be a curve depicting the sinusoidal waves of varying frequencies. In general, a single spatial frequency value may be used to represent the frequency response, which may indicate the spatial frequency value at which the refractive index modulation begins to drop or at which the refractive index modulation is reduced by 3 dB. The spatial frequency response may also be represented by lines/mm, line pairs/mm, or the period of the sinusoid.

The photosensitivity of the holographic recording material may indicate the photo-dosage used to achieve a certain efficiency, such as 100% (or 1% for photo-refractive crystals). The physical dimensions that can be achieved in a particular holographic material may affect the aperture size as well as the spectral selectivity of the HOE device. Physical parameters of holographic recording materials may include, for example, damage thresholds and environmental stability. The wavelength sensitivity may be used to select the light source for the recording setup and may also affect the minimum achievable period. Some materials may be sensitive to light in a wide wavelength range. Many holographic materials may need post-exposure development or bleaching. Development considerations may include how the holographic material is developed or otherwise processed after the recording.

To record holographic optical elements for artificial reality system, it may be desirable that the photopolymer material is sensitive to visible light, can produce a large refractive index modulation Δn (e.g., high dynamic range), and have temporally and spatially controllable reaction and/or diffusion of the monomers and/or polymers such that chain transfer and termination reactions can be suppressed.

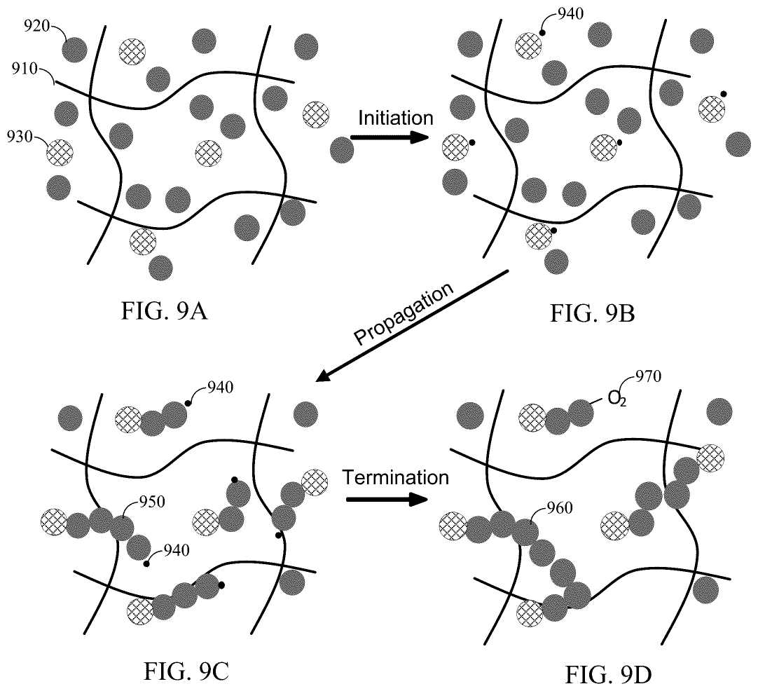

FIGS. 9A-9D illustrate an example of free radical polymerization in an example of a photopolymer material. Free radical polymerization can be used to polymerize a wide range of monomers, including olefins (e.g., ethylene and propylene) and vinyl monomers (e.g., vinylidene chloride, styrene, and methyl methacrylate), and is less sensitive to reactant impurities than, for example, anionic polymerization. Free radical polymerization generally includes the initiation, propagation, and termination of a monomer chain. In free radical polymerization, during the polymerization processes, monomer chains may be continuously initiated, propagated, and terminated.

FIG. 9A illustrates the photopolymer material before polymerization. The photopolymer material shown in FIG. 9A may include a polymer matrix 910 (e.g., polyurethane), unreacted writing monomers 920 (e.g., acrylate monomers), and initiators 930. As described above, in some embodiments, the photopolymer material may also include some photosensitizing dyes and/or chain transfer agents (not shown). Unreacted writing monomers 920 and initiators 930 may be dispersed in polymer matrix 910.

FIG. 9B illustrates the initiation of monomer chains, where radicals 940 are generated. Radicals for polymerization may be generated by, for example, photolysis, thermal decomposition, ionizing radiation, electrolysis, and the like. In the example shown in FIG. 9B, radicals 940 may be generated from the initiators immediately upon exposure to holographic recording light, which may cleave a bond in the initiators to produce the radicals.

FIG. 9C illustrates the propagation of the monomer chains, where radicals 940 may initiate the polymerization and propagate to chain ends to add more monomers. As described above, radicals 940 may initiate the polymerization by attacking a monomer 920. For example, in some monomers, an electron pair may be loosely held in a pi bond between two carbon atoms, and a radical 940 may use one electron from the pi bond to form a more stable bond with a first one of the two carbon atom. The other electron from the pi bond may return to the second carbon atom and turn the whole molecule into another radical. Thus, a monomer chain 950 may start to be formed by adding additional monomers 920 to the end of monomer chain 950 and transferring radical 940 to the end of monomer chain 950 to add more monomers 920 to the chain. As described above with respect to FIG. 6, initiators 930 or radicals 940 may react with and attach to polymer matrix 910 by hydrogen abstraction and chain transfer reactions, such that monomer chains 950 attached to the initiators may be attached to polymer matrix 910 through the initiator.

FIG. 9D illustrates the termination of the monomer chains, where a radical 940 at the end of a monomer chain 950 may combine, for example, with a radical 940 at the end of another monomer chain 950 to form a longer monomer chain 960, or with inhibiting species 970 (e.g., O₂). In some embodiments, the polymerization may also be terminated by disproportionation of polymers, where a hydrogen atom from one chain end may be abstracted to another chain end to generate a polymer with a terminal unsaturated group and a polymer with a terminal saturated group.

The performance of a holographic photopolymer may depend on how species diffuse and react during polymerization. In free radical polymerization, the polymerization and diffusion generally occur simultaneously in a relatively uncontrolled fashion, which may lead to some undesirable results.

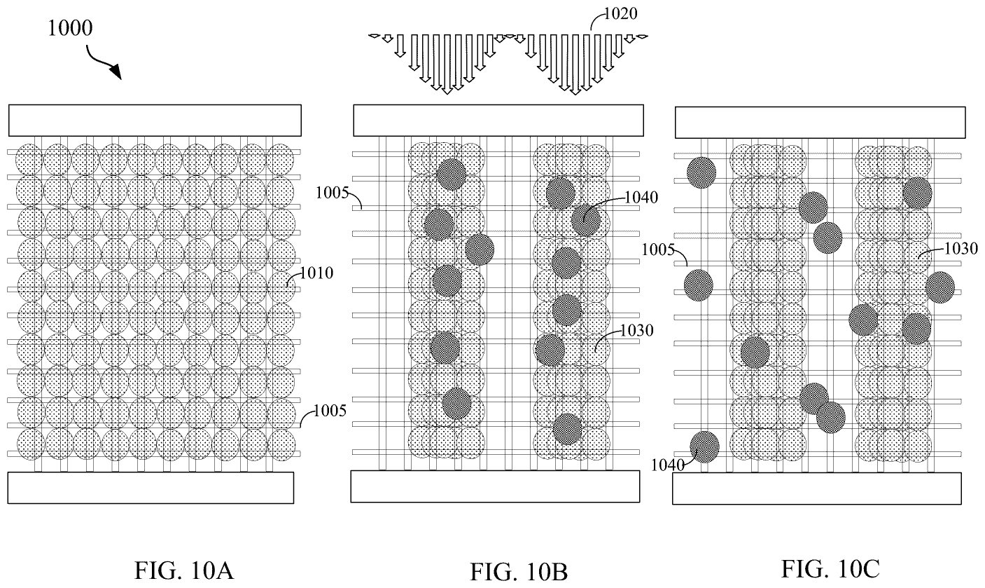

FIGS. 10A-10C illustrate an example of recording a holographic optical element in an uncontrolled photopolymer material layer 1000. FIG. 10A illustrates the unexposed photopolymer material layer 1000 that may include monomers 1010 suspended in a resin that may include a supporting polymer matrix 1005 (e.g., a cross-linked matrix formed by polymeric binders 622). Monomers 1010 may be substantially evenly distributed within photopolymer material layer 1000.

FIG. 10B illustrates an example of monomer diffusion and polymerization during holographic recording. When photopolymer material layer 1000 is exposed to a light pattern 1020, monomers 1010 may diffuse to the bright fringes in photopolymer material layer 1000 and polymerize to form polymers 1030 and 1040 in the bright fringes as described above. Some polymers, such as polymers 1030 may be bound to polymer matrix 1005. Some polymers, such as polymers 1040, may not be bound to polymer matrix 1005.

FIG. 10C illustrates an example of polymer diffusion after the holographic recording. As described above, some polymers 1040 that are formed in the bright fringes during the exposure and are not bound to polymer matrix 1005 may be free to diffuse in photopolymer material layer 1000. Some polymers 1040 may diffuse out of the exposed regions (e.g., the bright fringes) into unexposed regions, which may blur the resultant fringes of different refractive indices. In some cases, when the concentration of radicals on the exposed region is high, some unterminated radicals or radicals unattached to polymer matrix 1005 may also diffuse into the unexposed regions and cause polymerization in the unexposed regions. Thus, the diffusion of the unbound polymers or radicals into the unexposed regions may reduce the refractive index modulation Δn, the diffraction efficiency, and the minimum pitch of the recorded holographic optical elements.

In addition, during the exposure, the refractive index modulation Δn caused by the immediate initiation and polymerization may form intermediate holographic optical elements in the photopolymer material layer. The intermediate holographic optical elements may change the exposure light pattern in the photopolymer material layer, such as scattering or diffracting light in the exposure light pattern, which may lead to the formation of noisy gratings and cause haze and a loss of clarity in an optical system that uses such a holographic optical element, such as a waveguide display or eye-tracking system.

Furthermore, when the radical polymerization is uncontrolled (e.g., the polymerization continues after the exposure) and a series of exposures with constant dose or exposure is used to create a multiplexed hologram, the first exposure may consume most of the monomers, leading to an exponential decrease in refractive index modulation and diffraction efficiency for each subsequent exposure. Thus, a complicated dose scheduling procedure may be needed to balance the diffraction efficiency of the holograms in a multiplexed hologram.

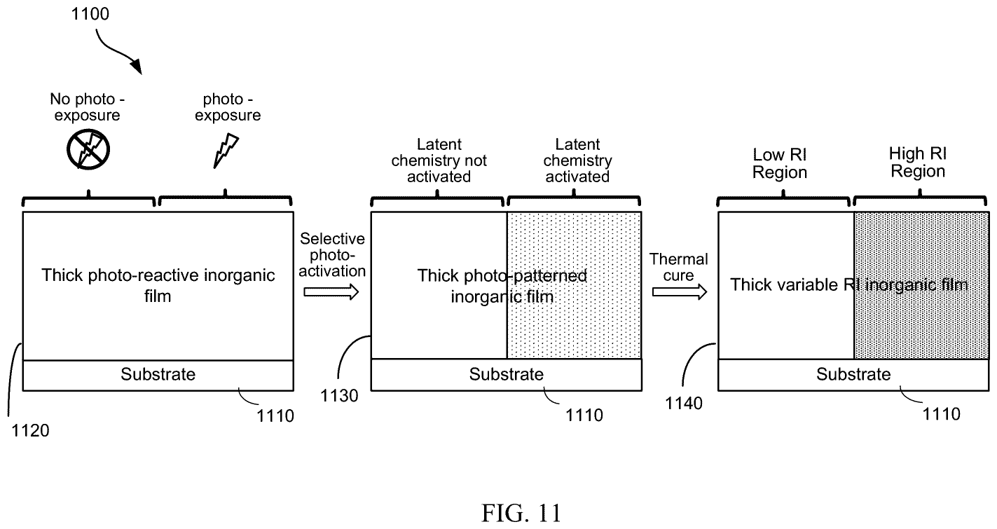

FIG. 11 illustrates an example of a process 1100 of generating RI modulation in a thick (e.g., >1000 nm) optical film. As depicted in FIG. 11, in process 1100, a thick photo-reactive inorganic film 1120 may be deposited on a substrate 1110. The thick photo-reactive inorganic film 1120 may undergo selective photo-activation where one or more regions of the thick photo-reactive inorganic film 1120 may be exposed to light. The selective photo-activation may form a thick photo-patterned inorganic film 1130 where the photo-exposed and unexposed regions create a pattern in the thick inorganic film. The photo-exposed regions of the thick photo-patterned inorganic film 1130 can be further activated via latent chemistry, whereas the unexposed regions are not activated. The thick photo-patterned inorganic film 1130 may be thermally cured to form a thick inorganic film 1140 with variable RI. In the example illustrated in FIG. 11, the photo-exposed, latent chemistry-activated regions of the film 1140 may have a higher RI, whereas the unexposed regions of the film may have a lower RI. In some examples, the photo-exposed, latent chemistry-activated regions of the film 1140 may have a lower RI, whereas the unexposed regions of the film may have a higher RI.

Thick coatings of photo-reactive materials that can have a local change in refractive index (RI) upon light excitation can be used to record Volume Bragg Gratings (VBG), and holographic patterns with high angular selectivity. These materials may be used as waveguide (WG) display devices or components in VR/AR/MR display systems, where the photo-generated pattern may control the refraction and diffraction efficiency of light as it travels through the coating. The thickness of the coating may influence the coating's ability to maintain a high angular selectivity. But coatings with high thicknesses may have more optical artifacts (e.g., rainbows and leakage) and/or other issues that may be detrimental to image quality.

It may be desirable that a WG display device has a high coating thickness (e.g., greater than about 300 nm, greater than about 500 nm, greater than about 600 nm, greater than about 1000 nm, or higher) after the material is processed. Moreover, it may be desirable that the thickness difference between photo-exposed and unexposed areas is small (e.g., less than 20% of total coating thickness), in order to prevent surface scattering and diffraction due to variations in the coating thickness along the length of the WG display device, which can lead to optical artifacts (e.g., ghost images or decreased image quality, such as pupil swim). Furthermore, periodic variations in coating thickness, such as distinct thickness changes in the exposed regions, may create surface relief gratings having diffractive behaviors that may disrupt the functionality of the overall WG display system.

It may also be desirable that the WG display device has a large RI contrast or RI modulation (Δn) between photo-exposed areas and unexposed areas. For example, it is desirable that the WG display devices have Δn larger than 0.05. This is because, generally, the WG display devices with higher Δn may have higher diffraction efficiencies. Furthermore, it is desirable that the photo-exposed and unexposed areas are transparent to visible light (e.g., with absorption <0.1%/100 nm) after the material is fully processed. That is because, for the coating to allow total internal reflection (TIR) and ambient light to pass through with minimal absorptive losses, it is desirable that the material has a low or minimum absorption of the light traveling through it. Otherwise, if either the photo-exposed or unexposed areas can absorb visible light, the efficiency of the WG display system will be lowered.

In addition, the photo-exposure may lead to a pattern of chemical or thermal reactivity where further processing (e.g., thermal annealing) may leads to a distinct change in the RI. This behavior is referred to as photo-induced latent chemistry, where the photo-exposure itself does not lead to a significant change in RI; rather, the photo-exposure creates a pattern of reactivity in the material that can be exploited in a subsequent step (e.g., thermal annealing) to induce distinct changes in the RI. The latent chemistry behavior is desirable when the patterns are formed by photo-exposure utilizing constructive and destructive interference of the light source. Moreover, by exploiting the latent chemistry behavior, nano-scale resolution between the photo-exposed and unexposed areas may be achieved.

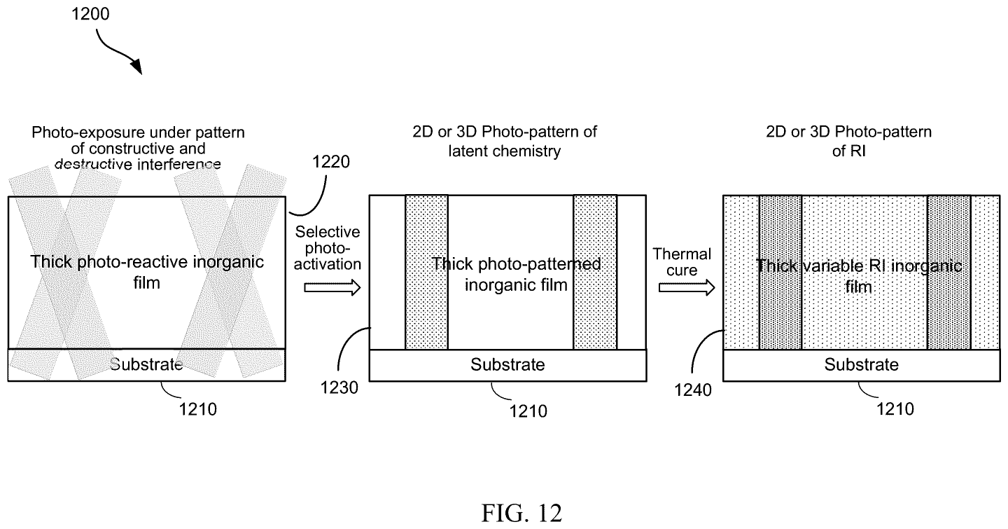

FIG. 12 illustrates an example of photo-patterning via latent chemistry behavior following the photo-exposure. As shown in FIG. 12, in the photo-patterning process 1200, a thick photo-reactive film 1220 may be deposited on a substrate 1210. The thick photo-reactive film 1220 may undergo selective photo-activation, where the constructive and destructive interference of the light source is utilized to create a thick photo-patterned inorganic film 1230. The thick photo-patterned inorganic film 1230 may be thermally cured to form a thick inorganic film 1240 with variable RI.

In some cases, the generation of a local Δn during photo-exposure can cause diffraction of the light that is used to photo-pattern the material, thereby leading to parasitic grating formation. Moreover, local Δn formed during photo-exposure can lead to other aberrations in the diffraction and refraction behaviors of the fabricated device. By de-coupling photo-excitation from Δn formation (e.g., decoupling photo-exposure and thermal annealing), the photo-reactive material can be exposed for as long as needed without compromising the quality of Δn pattern.

Furthermore, the photo-excitation or post-processing may not entail the long-range (e.g., >10 nm) reorganization of components within the material. Long-range reorganization of the components can potentially cause scattering issues. For example, when photo-exposure or post-processing results in the displacement of a given component (e.g., by displacing a particle or forming an organic polymer chain), there may be a significant risk that the components may agglomerate into units that are larger than 1/10 of the wavelength of light. The agglomerates may scatter light as the light travels through the optical coating, which may negatively impact the image quality of the WG display devices.

Therefore, there is a need for materials for thick (e.g., >300 nm, >500 nm, >600 nm, >1000 nm, or thicker) optical coatings for WG display devices that may be formed by exposure to a light source and subsequent thermal annealing, which may lead to a large Δn. Furthermore, the photo-exposed and unexposed areas in the optical coatings may need to be transparent to visible light and have minimal variations in film thickness after the material is fully processed. If the photo-exposed or unexposed areas absorb visible light, the efficiency of the WG display system may be lowered.

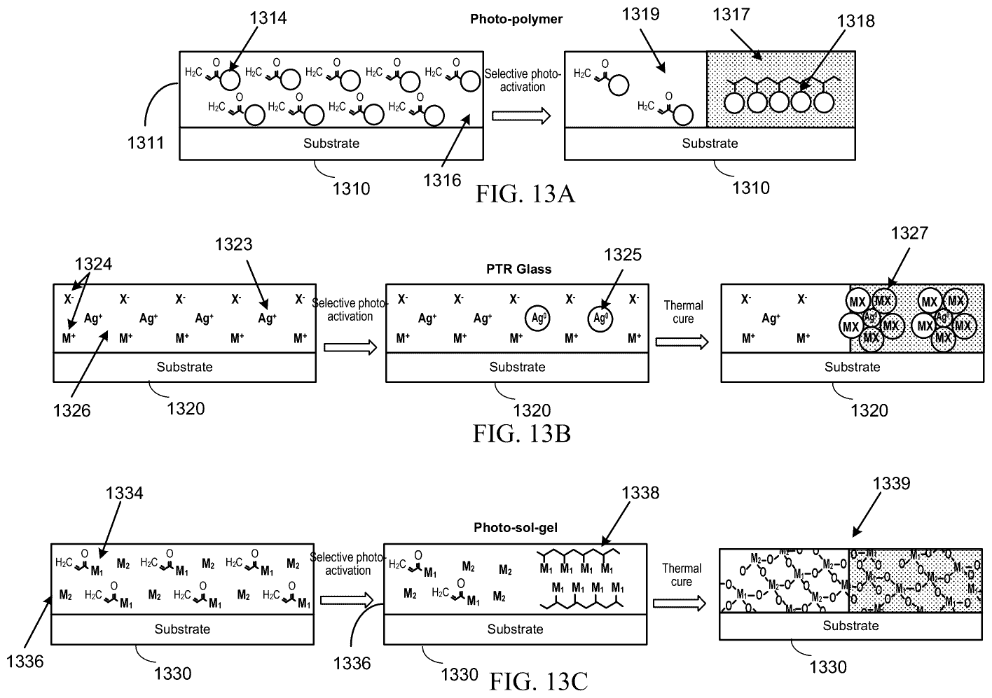

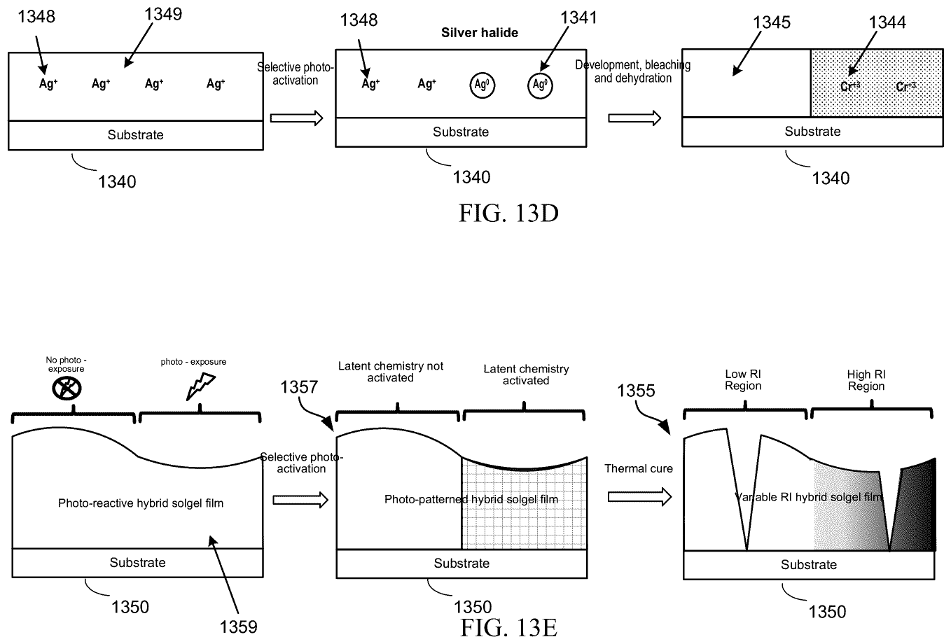

FIGS. 13A-13E illustrate some examples of materials and processes for recording holographic optical elements (e.g., VBG) or holographic patterns. A common material platform utilized to fabricate VBG or other holographic patterns within optical films is organic photopolymers, as shown in FIG. 13A and described above with respect to FIGS. 9A-10C.

As depicted in FIG. 13A, a substrate 1310 may be coated with a film 1311 of photopolymer. The film 1311 may include two components. The first component 1314 is a photo-reactive monomer or oligomer that can be polymerized via light excitation. When excitation occurs in specific regions of the film, the first component 1314 is locally consumed to grow polymer chains 1318, triggering the displacement of the first component 1314 away from the unexposed areas and depleting the unexposed area of the first component 1314. The local photo-excitation that induces the movement of the photo-reactive first component 1314 may lead to a gradient of refractive indexes across the film 1311, or create regions 1317 and 1319 of different refractive indexes in the film 1311. The second component 1316 is a polymer that provides support for the photo-reactive first component 1314, allowing it to diffuse and photo-polymerize, while minimizing variations in thickness and mechanical properties that may occur upon photo-polymerization. The first component 1314 and the second component 1316 generally have different RI values. The second component 1316 may not react with light. In some embodiments, the second component 1316 may be cured or polymerized in a subsequent blanket UV-cure or thermal step.

A limitation of photopolymer material is that it relies on the large-scale displacement of the first component 1314 to create a pattern of optical properties in the film 1311. In many cases, the internal diffusion of the photo-reactive first component 1314 is limited by the thermomechanical and rheological properties of the mixture (e.g., the two components 1314 and 1316). For example, as the viscosity, glass transition temperature Tg, and permeability of the scaffold decrease, the diffusion capabilities may improve, although at the expense of mechanical stability and recording fidelity. Furthermore, in some cases, the localization of the photo-active first component 1314 can lead to aggregation. The aggregation can result in scattering between the domains, significantly vary the thickness between photo-exposed regions 1317 and unexposed regions 1319, or deform the shape of the photo-recorded features.

In addition, photo-patterning relying on actively changing local optical properties without latent chemistry may lead to further patterning limitations. For example, the local RI of the material may actively shift with ongoing photo exposure, and thus increasing the exposure time and recording density can cause more parasitic feature formation.

The organic nature of the photo-reactive first component 1314 makes it challenging to maintain high flow and diffusivity, while also increasing the base RI of each component significantly >1.5. For example, increasing RI in organic components may entail the incorporation of rigid, aromatic, or larger heteroatom moieties that may reduce flow. Since the RI changes may depend on the mobility of first component 1314, the organic photo-polymer mixtures typically have modes of overall RI values, and the local variation in RI may be low, such as well below 0.1.

In addition, organic materials and polymers (e.g., components 1314 and 1316) usually have large coefficients of thermal expansion (CTE) as compared to inorganic substrates 1310 that the photopolymer is deposited onto. This CTE mismatch can introduce thermomechanical integration issues that may often lead to interfacial failure or deformation of multi-layer components, ultimately resulting in failures in reliability and stress testing of the overall optical device.

Overall, the mechanistic and materials limitations of the organic photopolymers of FIG. 13A indicate that they may not be compatible with latent chemistry photo-patterning and the base RI and RI modulation values may not be increased significantly above 1.6 and 0.1, respectively, without decreasing optical performance and image quality.

Photo-thermo-refractive (PTR) glasses may be an inorganic alternative to photopolymer and may also rely on the displacement and aggregation of formulation components to generate variations in RI. In the example shown in FIG. 13B, the material may be a silicate glass 1326 that is formed on a substrate 1320. The material includes RI contrast elements 1324, such as Na⁺ and F⁻, and is doped with photo-reactive species 1323, such as Ag⁺ and Ce⁺³. Local photo-excitation may lead to the formation of a pattern of latent chemistry by creating nanoclusters 1325 (e.g., Ag nanoclusters) that can serve as nucleation sites for the RI contrast species upon subsequent thermal annealing. For example, heating at >300° C. may lead to the segregation of RI contrast elements 1324 (e.g., NaF) around the photo-generated nanoclusters 1325, forming clusters 1327. In some examples, RI contrast elements 1324 (e.g., NaF) may have a lower RI (e.g., about 1.32) than silicate glass 1326 (e.g., with a refractive index about 1.45-1.55), and thus the segregation may result in a pattern of local RI variations.

While the PTR glass may have better mechanical and optical stability than the photo-polymer examples shown in FIG. 13A, the RI contrast elements 1324 in the PTR glass need to diffuse through the denser silicate glass 1326, which may limit the optical properties of the PTR glass. For example, at high annealing temperatures, the rate of RI contrast component segregation may be in competition with the rate of homogeneous mixing of the overall material. Thus, the formation of the RI variation pattern can be in direct competition with a process that erases the RI pattern and homogenizes the optical properties.

In addition, the growth rate of RI contrast elements 1324 may be higher than the nucleation rate. In such cases, the increase in RI contrast may occur at the expense of domain formation and potential haze from the domains that may grow too large.

Therefore, while the PTR glass may have a distinct latent chemistry photo-patterning mechanism, the PTR glass may have relatively low base RI values, and may not be able to produce VBG or holographic patterns with RI variations above 0.001.

Sol-gels have been used as an alternative inorganic material class with improved diffusion and reorganization potential. In the example shown in FIG. 13C, a sol-gel coating 1336 formed on a substrate 1330 may include metal oxide precursors 1334 that can be polymerized via light excitation. Upon selective photo excitation of the specific regions of the sol-gel coating 1336, the metal oxide precursors 1334 may be locally consumed to grow polymer chains 1338. The sol-gel coating 1336 may progressively condense upon heating due to elimination of solvent and organic ligands to form a glassy state 1339. The condensation process may be accompanied by a significant reorganization of the coating's microstructure and shrinkage of the coating. Therefore, improved diffusion may need to be leveraged against local thickness variations and patterned feature deformation.

Sol-gel coatings may be used to form VBG and record holographic patterns by incorporating a photo-polymerizable organic ligand that enables a photo-induced segregation behavior similar to that of photopolymers. Thus, sol-gel coatings may have similar limitations as the photopolymers in terms of limited RI variation, scattering, and pattern integrity issues due to the lack of a latent chemistry mechanism. For example, the photo-induced RI variations in these films are generally lower than 0.1, even though the base RI of the organic components can be much higher than that of organic photopolymer materials.

In addition, the increased coating shrinkage observed when sol-gel films are annealed indicates that the final local thickness variation issues may be pronounced. The thickness variation can lead to the formation of a secondary surface indentation pattern, in addition to the photo-induced pattern within the film. This indentation pattern can also diffract and/or refract light, thus lowering the quality of images produced by the photo-recorded pattern.

Thus, while sol-gels can provide improved diffusion over PTR glasses and increased base RI compared to organic-photopolymers, the photo-patterning still relies on diffusion and segregation, and the local RI variation may be lower than 0.1.

VBG and holographic patterns can be recorded onto gelatin layers sensitized with dichromate or silver halide. For example, photo-induced reduction of Cr^{VI} centers within a hydrated gelatin coating can be used to control local cross-linking of the gelatin scaffold. Through a series of aging and wet post-processing steps, the unreacted Cr^{VI} may be removed, and the partially reduced Cr in the photo-exposed areas may be reduced to Cr^{III}. Once the gelatin is dried, the areas that contain Cr^{III} may have higher densification, while the unexposed areas might be denser or even show micro-voids; thereby creating a pattern of local RI variations within the gelatin layer.

FIG. 13D depicts a process of using a gelatin layer 1349 containing photosensitizer 1348 (shown as Ag⁺) to create local RI variations in a film formed on a substrate 1340. The photosensitizer 1348 (e.g., Ag⁺) may oxidize the gelatin upon light exposure. Light exposure may form clusters 1341 of oxidized photosensitizers (shown as Ag⁰). Upon removal of soluble photosensitizer 1348 (e.g., Ag⁺) from the non-exposed areas 1345, the clusters 1341 may be bleached and replaced by Cr^{III} 1344, which helps to increase the local density of the gelatin.

While this approach allows for recording via latent chemistry onto gelatin layers with high transmission and low scattering, it may suffer from the optical and reliability challenges of organic materials. For example, the base RI of gelatin is moderate (˜1.54), and the RI variation is usually below 0.1. Moreover, in the case of Ag halide, scattering of the Ag emulsion and the photo-exposed product can also introduce image quality issues. In addition, the hygroscopic nature of the gelatin scaffold may need complete encapsulation of the layer to prevent variations in RI or complete erasing of the photo-generated pattern. Thus, the application of this type of material in consumer products, such as waveguides for wearable electronic displays, is limited.

SnO(n)Cl(m) coatings can be formed using a non-hydrolytic sol-gel approach, wherein the Sn valence and O vs. Cl ratio can be controlled by the sol-gel solvent choice. For example, the coatings may show constant RI values that range from 1.60 to 2.10. The same SnO(n)Cl(m) material class may be used to create coatings with variable RI values. The local RI control may be resulted from gradual changes in solvent type and content in the coating prior to annealing. For example, by increasing the content of isopropanol solvent in portions of the coating, the RI can be reduced to 1.6, whereas other portions enriched with DPGME solvent may show RI values as high as 2.1. The local solvent variations can be achieved via selective deposition techniques such as ink-jet printing. Furthermore, since the final coatings are primarily made up of inorganic components, their environmental stability, reliability, and integration compatibility with inorganic substrate are more promising than organic counterparts.

While this material class appears to strongly respond to slight changes in its chemical environment by shifting its post-anneal composition and RI, those changes in the chemical environment may not be induced via photo-excitation. It is thus necessary to develop new materials and process that allow for recording patterns of RI variations using light, with material base RI >1.6 and RI modulation >0.1.

Hwang et al. (Electrochemical and Solid-State Letters, 15 (4) H91-H93 (2012), DOI 10.1149/2.013204esl) shows that a Zinc-Tin Oxide coating made from a solution of SnCl₂, Zn(AcO)₂, Acetylacetonate and alcohol solvent can be annealed to SnO₂, and that photo-excitation of the film prior to annealing can accelerate the condensation process. This example showed no photo-patterning ability, the excitation wavelength was deep in the UV range, the anneal temperatures were too high for compatibility with other common temperature-sensitive coating used in WGs, the photoexcitation times were too prolonged for high-fidelity recording of WG features, and the deposit thickness was <25 nm.

Sanctis et al. (Adv. Mater. Interfaces 2018, 1800324, DOI: 10.1002/admi.201800324) similarly shows that an Indium/Zinc-Tin Oxide pattern can be photo-generated via photo-condensation of metal-Schiff base complex into insoluble deposits. After washing away the material from non-exposed areas and annealing the deposits, mixed photo-patterned features of mixed tin(IV) oxides are obtained. In this example, there is no local RI variation (since the material is fully removed from non-exposed areas), the deposit thickness is <25 nm, and excitation times are too long and anneal temperatures too high for application in the manufacturing of WG devices.

FIG. 13E illustrates a process of generating VBG and holographic patterns in a photo-patternable sol-gel film with a large thickness. The sol-gel film may be a SnO(n)Cl(m) coating 1359 containing a photo-acid generator (PAG) formed on a substrate 1350. Upon selective photo exposure, coating 1359 forms a photopatterned sol-gel film 1357. The photopatterned sol-gel film 1357 may be thermally annealed to produce large changes in local RI. For example, when thermally annealed, photopatterned sol-gel film 1357 may form a film 1355 with variations in local RI, where the non-exposed regions may have lower RI while the exposed regions may have higher RI. However, as depicted in FIG. 13E, the sol-gel film may have poor uniformity and mechanical stability when the thickness is increased beyond a critical threshold. For SnO(n)Cl(m) coatings deposited via spin-coating, the threshold may be less than about 600 nm. When the thickness of the coating approaches the threshold, the film can become highly uneven, such as with >10% thickness variations across the material. This variation in thickness can prevent the even recording of RI patterns with an acceptable patterned feature shape. In addition, the thickness variation can introduce local variations in how light transverses in the waveguide, thereby decreasing the optical quality of the device.

As the thickness of a SnO(n)Cl(m) coating deposited via spin-coating approaches 600 nm, the coating can also show haze. The haze may be caused by scattering from grains and cracks formed during the thermal annealing of the film. The grains and cracks may be caused by the inherent shrinking behavior of sol-gels when they are thermally cured. The shrinking process can cause a build-up of strain in the coating as the sol-gel condenses at high temperatures. Usually, the thicker the coatings experience higher the stress build-up. When the stress exceeds an upper threshold of a given sol-gel material, the stress will be relieved via crack formation. For optical coatings for WG applications, cracks are defects that disrupt the flow of light through the device, decreasing WG efficiency and image quality.

Thus, there is a need to increase the coating thickness of SnO(n)Cl(m) photo-sol-gel such that it can be coated and cured to yield a film with high final thicknesses (e.g., >500 nm, >600 nm, >1000 nm, or higher). A suitable new material or approach should increase high-quality coating thickness without compromising the photo-reactivity of the SnO(n)Cl(m) component, such that the thick coating may be used to create large local RI variations using light.

In some embodiments, the thickness and thickness variation limitation of the SnO(n)Cl(m) coatings may be addressed by incorporating a resin matrix.

In various embodiments, the resin may be compatible with a sol-gel solution such that it may be mixed with the sol-gel solution without forming precipitates, and the resulting resin mixture (also referred to as ‘hybrid resin-sol-gel mixture’) may be coated to yield a film (also referred to as ‘hybrid sol-gel films,’ ‘hybrid sol-gel coating,’ or ‘hybrid resin-sol-gel’) with a high thickness. In some embodiments, the resin mixture may be coated via spin-coating, casting, inkjet printing, or spray-coating. In addition, the resin may withstand extreme sol-gel environments while still being curable. For example, it may not degrade or lose the ability to be cured in the low pH of the sol-gel and may not degrade at the high temperature (>150° C.) used to cure the sol-gel.

In some embodiments, the resin may have a high-RI (>1.6) matrix once cured, and incorporation of the resin does not reduce the base refractive index of the sol-gel component. In various embodiments, the resin does not disrupt coordination chemistry around metal, such that photo-reactivity and condensation chemistry are maintained.

In various embodiments, a sol-gel component in the hybrid sol-gel coating may be photo-patternable, and the resin may be cured through orthogonal processes, such that the ARI may be varied depending on device requirements without compromising whether the hybrid sol-gel coating can be cured.

In some embodiments, the resin may incorporate thermal silicone, UV acrylate, or UV sulfide components, which are further incorporated into the hybrid resin-sol-gel (precursor) solution.

In various embodiments, the thermal silicone for the resin may have two components. The first component contains a poly-alkyl or aryl siloxane monomer terminated with hydride or alcohol groups. The second component contains a hardener or crosslinking agent (e.g., tetra alkoxide silane or multi-siloxane-containing molecule), a catalyst (e.g., platinum or tin compound or a Lewis acidic moieties), and an optional organic solvent.

In some embodiments, the two components may be mixed with the sol-gel without leading to precipitation of the components, and the mixture may be coated via spin-coating. In various embodiments, the initial thermal dry and photo-patterning of the hybrid resin-sol-gel may be completed without triggering the silicone resin to cure. In some embodiments, during a final high-temperature anneal, silicone and patterned sol-gel may be cured, resulting in a coating with a high thickness, low thickness variation (<5%), and good coating quality.

In some embodiments, the UV acrylate or UV sulfide resin contains an acrylate, methacrylate monomer, oligomer containing one or more aryl or thioether groups, a cross-linker unit, a photo-initiator, or an adhesion promotor, and an optional organic solvent. The cross-linker unit may include a molecule containing two or more acrylate or methacrylate groups, or two or more thiol groups. The photo-initiator may include phosphine oxide or phosphonic acid containing alkyl, aryl, and/or acyl groups. The adhesion promotor may include silane, or siloxane compound containing one or more alcohol or alkoxide groups and one or more alkyl or aryl groups bonded to the silicon center.

In various embodiments, the UV acrylate components may be mixed with the sol-gel solution without leading to precipitation of components. The mixture of UV acrylate component and sol-bel solution may be coated via spin-coating. In various embodiments, the initial thermal dry does not trigger the polymerization of the resin matrix. The sol-gel photo-patterning step may induce cross-linking of the resin and/or sol-gel. In many embodiments, sol-gel reactivity may be faster than resin reactivity which enables a degree of orthogonality. In some embodiments, the hybrid sol-gel coating may undergo a final high-temperature anneal, forming a hybrid sol-gel film having high thickness with low thickness variation (<5%) and good coating quality. In some embodiments, during the final high-temperature anneal, the sol-gel may be condensed, and some of the resin may also undergo further reactivity.

In some embodiments, resins may be mixed with a solution containing tin dichloride, an alcohol-containing solvent or solvent mixture, and an optional photo-sensitizer (e.g., a photo-acid generator, photo-base generator, photo-redox agent, or radical-initiator).

According to certain embodiments, a hybrid resin-sol-gel material for recording holographic optical elements (e.g., volume Bragg gratings) may be a solution containing tin dichloride salt, at least one alcohol-containing solvent, optionally a photo-initiator, and a high-RI support matrix mixture. The high-RI support matrix mixture may contain a thermal silicone-forming, UV polyacrylate-forming, UV polymethacrylate-forming, or UV polysulfide-forming mixture. The hybrid resin-sol-gel material may form a thick (e.g., >500 nm, >600 nm, >1000 nm, or higher) and homogeneous coating containing tin oxychloride and resin where the local RI may vary across the length of the coating dimensions as a result of selective photo-excitation followed by a blanket thermal annealing.

In some embodiments, the tin dichloride salt may be anhydrous tin dichloride or tin dichloride hydrate. In some embodiments, tin(II) ions and chloride ions are provided to the solution from separate salts. The solvent may contain at least one alcohol such as an alkyl alcohol, a glycol, or a diol. The solvent may be a solvent mixture that may include at least one of the following solvents: dipropylene glycol monomethyl ether (DPGME), propylene glycol monomethyl ether (PGME), ethanol, isopropanol, propanol, and diethylene glycol, propylene glycol methyl ether acetate, tripropylene glycol monomethyl ether, butyl lactate, propylene carbonate, methanol, or water. The coating solution may optionally include a photo-sensitizer such as a photo-acid generator, a photo-base generator, a photo-redox agent, or a radical initiator. The photo-acid generator or photo-acid may include at least one of the following compounds: triarylsulfonium compound, diazomethane compound, bis(sulfonyl)diazomethane compound, diaryliodonium compound, triarylselenonium compound, arene ferrocene compound, or sulfonic acid ester compound.

In various embodiments, the sol-gel (precursor) solution may contain poly alkyl or aryl siloxane oligomer of Structure 1, a hardener or crosslinking agent of Structure 2, and a cross-linker of Structure 3, a catalyst, and optional organic solvent. In Structure 1, R₁ and R₂ are hydrogen or alcohol groups or both; R₃-R₈ are alkoxide, alkyl or aryl groups or a mixture of the three, where the alkoxide, alkyl or aryl is composed of a chain of 1-9 carbon atoms, and the chains are either linear or branched; and n is 0-50. In Structure 2, R₉-R₁₂ is a combination of, or all hydrogen, alcohol, alkyl, aryl or alkoxide, where the alkyl, aryl or alkoxide is composed of a chain of 1-9 carbon atoms, and the chains are either linear or branched. In Structure 3, R₁₃ is an alkyl group or aryl group containing 1-9 carbon atoms; R₁₄ is an alkoxide, bisalkoxide, alkyl or aryl group containing 0-8 carbon atoms; R₁₅-R₁₇ are a combination of, or all hydrogen, alcohol, alkyl, aryl or alkoxide where the alkyl, aryl or alkoxide is composed of a chain of 1-9 carbon atoms, and the chains are either linear or branched; and m is 2-4.

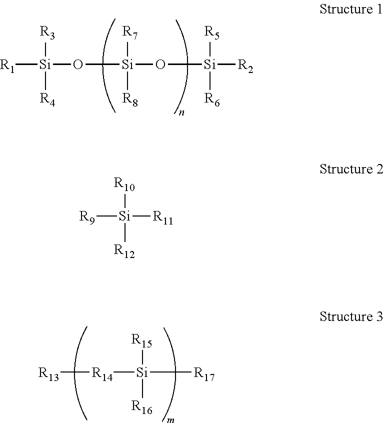

In some embodiments, a coating may be prepared from the hybrid resin-sol-gel precursor solution to form a layer containing SnO(n)X(m). Once the coating is thermally annealed and optionally photo-cured, the coating may have a refractive index between 1.65 and 2.35, where all portions of the film show absorption values <0.1% in the visible spectrum. In some embodiments, a coating composed of SnO(n)X(m) has variable n-m values and the n:m ratio. n-m values and the n:m ratio that can be varied by selective photo-curing of the coating prior to completing the thermal annealing process. In some embodiments, the local RI values of the coating may vary from 1.65 to 2.35, and all portions of the film have absorption values <0.1% in the visible spectrum. In some embodiments, photo-exposed regions of the coating have RI values that are lower than the non-photo-exposed regions, and the photo-exposed regions may have an n value of 1.5-2 and an m:n ratio >3. In some embodiments, the m-n values, m:n ratio, and resultant local RI values of a coating disclosed herein may be controlled by the intensity, exposure time, and wavelength of photo-excitation followed by thermal annealing.

In various embodiments, the sol-gel (precursor) solution may contain a poly acrylate/methacrylate compound of Structure 4, a cross-linker of Structure 5, a cross-linker of Structure 6, a catalyst, and optional organic solvent. In Structure 4, R₁₈ is hydrogen or methyl; R₁₉ is a C2 fragment with a carbon-carbon double bond; and R₂₀ is an alkyl or aryl chain containing 1-15 carbon atoms. In Structure 5, R₂₁ is an alkyl group or aryl group containing 1-8 carbon atoms; R₂₂ is an alkyl group or aryl group containing 0-8 carbon atoms; R₂₃ is hydrogen or methyl; and o is 2-4. In Structure 6, R₂₄ is an alkyl or aryl chain containing 1-15 carbon atoms, where R₂₅ is an alkyl group or aryl group containing 1-8 carbon atoms; R₂₆ is an alkyl group or aryl group containing 0-8 carbon atoms; and p is 2-4.

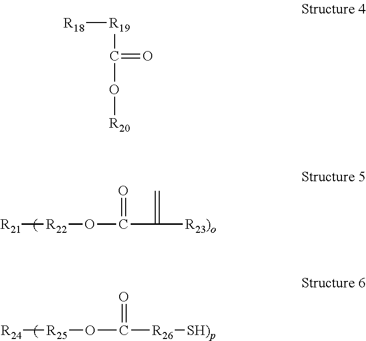

In some embodiments, a coating may be prepared from the hybrid resin-sol-gel precursor solution to form a layer containing SnO(n)X(m) and silicone, polyacrylate, polymethacrylate or polysulfide resin. Once thermally annealed and optionally photo-cured, the coating may have a high thickness (e.g., greater than about 500 nm, about 600 nm, about 1000 nm, or thicker), a RI between about 1.55 and 2.20 where all portions of the film show absorption values <0.1% in the visible spectrum. In some embodiments, the coating has variable n-m values and n:m ratio may be varied by selective photo-curing of the coating prior to completing the thermal annealing process. such that local RI values may vary from about 1.55 to 2.20 and all portions of the film may show absorption values <0.1% in the visible spectrum. In some embodiments, the photo-exposed regions of the coating have RI values that are lower than the non-photo-exposed regions, and the photo-exposed regions may have an RI value of about 1.5-2 and an m:n ratio >3. In some embodiments, the m-n values, m:n ratio, and resultant local RI values of a coating disclosed herein may be controlled by the intensity, exposure time, and wavelength of photo-excitation followed by thermal annealing.

In some embodiments, the sol-gel precursor solution may be applied to a substrate via spin-coating, ink-jet printing, dip-coating, spray-coating, screen-printing, contact-printing, or casting, to form a layer of coating with a high thickness. In some embodiments, a portion of the coating may be cured using a light source with an excitation wavelength >365 nm and power <300 mW/cm² for 0.001 to 300 seconds. The photo-exposed areas may have a lower RI value than the non-exposed areas after thermal annealing. In some embodiments, a portion of the coating may be photo-cured using a light pattern formed by constructive and destructive interference to create a (latent) holographic optical element (e.g., VBG) within the coating, followed by thermal annealing. The substrate with the photo-cured coating may be thermally annealed via at least 1 stage of thermal annealing after photo-excitation where the annealing temperature is <300° C. In some embodiments, the coating may be thermally annealed via at least 2 stages of annealing, where the initial annealing may occur before or after the selective photo-excitation with a temperature <200° C. In 2 stages of annealing, the temperature of the final annealing is <300° C. After the thermal annealing, a transparent coating with local variations in RI may be formed, where the local RI may vary by at least 0.05, with an overall RI variability of 1.55-2.20.

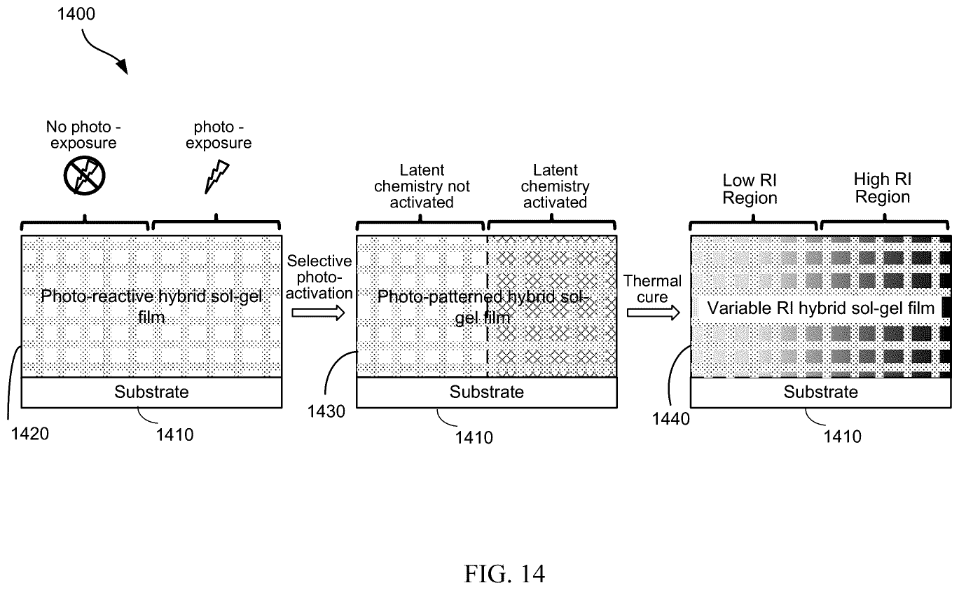

FIG. 14 illustrates an example of a process 1400 of fabricating an optical device using a thick photo-patternable hybrid resin-sol-gel material layer with selective photo-activation and refractive index modulation by latent chemistry. As illustrated in FIG. 14, in process 1400, a photo-reactive hybrid sol-gel film 1420 may be deposited on a substrate 1410. The photo-reactive hybrid sol-gel film 1420 may undergo selective photo-activation where the portion(s) of the photo-reactive hybrid sol-gel film 1420 may be exposed to a light source. Selective photo-activation may form a photo-patterned hybrid sol-gel film 1430, where the photo-exposed and unexposed regions may create a latent pattern in the photo-patterned hybrid sol-gel film 1430. The photo-patterned hybrid sol-gel film 1430 may be thermally cured to form a hybrid sol-gel film 1440 with variable RI. The photo-exposed, latent-chemistry-activated regions of the film 1440 may have a high RI, whereas the unexposed regions of the film may have a low RI. Experimental results of comparative examples and working examples are detailed below.

A photo-reactive material that can have local changes in RI upon photo-excitation may be used to fabricate surface relief gratings (SRG). The SRG material and grating-fill material may have a high RI difference (>0.3) and may be used as WG components in VR/AR/MR display devices. SRG devices may generally be manufactured by first etching or molding the grating material to create un-filled trenches. The vacant space between the trenches may then be filled with a material with a different RI via a variety of deposition methods. Unifying and simplifying the grating formation and fill processes would be advantageous for decreasing manufacturing complexity and cost.

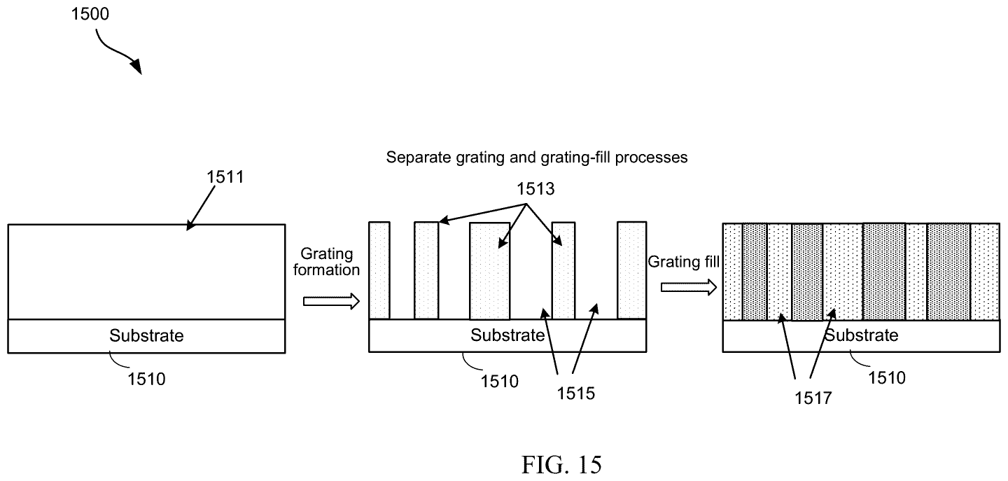

FIG. 15 illustrates an example of a process 1500 that may be utilized to form SRG grating and grating fill layers. SRG patterns for WG applications with high diffractive efficiency may be manufactured according to process 1500, which separates grating formation and grating-fill processes, as shown in FIG. 15. More specifically, a grating 1513 may be formed by etching a material 1511 on a substrate 1510. The material 1511 may be etched via reactive ion etching or other lithography processes. Alternatively, the grating 1513 may be formed by depositing a flowable material onto the substrate 1510 and applying a mold that shapes it into the SRG pattern, for example, via nanoimprint lithography. Once the grating 1513 are formed, the vacant spaces 1515 between the pattern may be filled with materials 1517 that have an RI contrast with respect to the grating 1513 of at least 0.3 to achieve high diffraction efficiency. The target RI value may vary depending on the RI of the material of the grating 1513, but it may be desirable that the RI of both materials be as high as possible to increase the field-of-view of the WG device. For example, the grating 1513 may be filled with high RI organic, nanocomposite, or sol-gel materials. Deposition methods may include spin-coating, IJP, blade-coating, dip-coating, and screen-printing. Overall, separating steps for forming grating and filling introduces large process complexity and increases the cost of the manufacturing approach. As a result, there is a need for new materials and methods to create both gratings and grating-fill through a unified process.

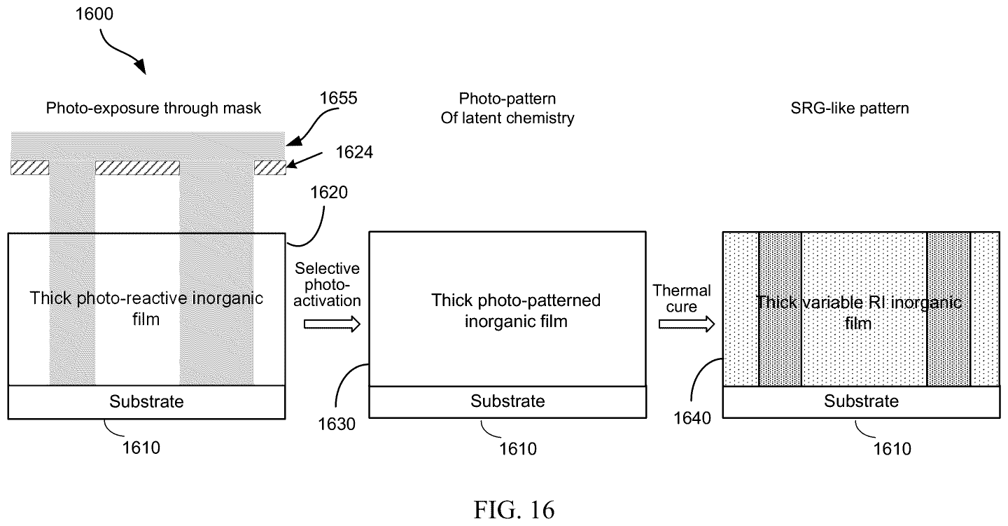

FIG. 16 illustrates an example of a process 1600 of photo-patterning via latent chemistry following photo-exposure through a mask to create surface-relief grating (SRG)-like patterns. The grating and fill layers may be manufactured via a coating, exposure, and cure process using a coating of a photo-reactive material, where light excitation leads to a local change in RI. As illustrated in FIG. 16, in process 1600, a thick photo-reactive inorganic film 1620 may be formed on a substrate 1610. The thick photo-reactive inorganic film 1620 may be patterned by selective photo-exposure to a light beam 1655 through a mask 1624 to create a thick photo-patterned inorganic film 1630. The thick photo-patterned inorganic film 1630 may be thermally cured to form a thick inorganic film 1640 with variable RI.

To create an SRG pattern with photo-reactive material that has high efficiency and image quality, it may be desirable that the material can be deposited with a high quality in thickness regime between about 100 nm and about 5000 nm.

In addition, it may be desirable that the device has large RI contrast or RI modulation (Δn) between photo-exposed areas and unexposed areas (e.g., Δn>0.3). This is because higher diffraction efficiency of the WG device may be achieved in devices with higher Δn. Moreover, it is desirable that both photo-exposed and unexposed areas are transparent to visible light after the material is fully processed (e.g., with absorption <0.1%/100 nm and Haze <0.1%). This is because, for the coating to allow total internal reflection (TIR) with minimal absorption losses, the material should not be capable of electronic absorption of the light traveling through it. If either the photo-exposed or unexposed areas can absorb visible light, the efficiency of the WG display device will be lowered.

Moreover, the photo-exposure should lead to a pattern of chemical or thermal reactivity where a distinct change in the RI index is observed after the post-processing. This behavior is referred to as photo-induced latent chemistry, where the photo-exposure itself does not lead to a significant change in the RI, and the latent chemistry may be important during the photo-exposure process to achieve nm-scale resolution between photo-exposed and unexposed areas. The reason is that the generation of a local ΔRI during exposure can itself diffract the light used to photo-pattern the material, thereby leading to parasitic grating formation or other aberrations in the diffraction and refraction behavior of the pattern. By de-coupling photo-excitation from Δn formation into two separate processing steps (i.e., decoupling photo-excitation and post-processing), the photo-reactive material can be exposed for as long as necessary without compromising the quality of ΔRI pattern.

Furthermore, photo-excitation or post-processing may not entail the long-range (e.g., >10 nm) reorganization of components within the material to prevent potential scattering issues. That is, if photo-exposure or post-processing results in the displacement of a given component, such as a particle or a growing organic polymer chain, there may be agglomeration of components into units that are larger than 1/10 of the wavelength of light. As a result, the agglomerates can scatter light as it travels through the optical coating, and the image quality of the WG will be severely impacted. Material may be compatible with photo-patterning in a low-flow or high-viscosity state where diffusion of the material components is minimized, such that the photo-generated pattern with 100-1000 nm shapes may not blurred or deformed as it is generated or processed.

Thus, there is a need for materials that can be incorporated into WG devices with high Δn, high shape-fidelity of the optical coatings, and react to photo-excitation to create a pattern of latent chemistry that leads to a large Δn upon post-processing. In such materials, a single and simultaneous process flow may be used to create the grating and grating fill. These materials should be fully transparent in both photo-exposed and nonexposed areas once post-processing is completed, and able to retain pattern shape fidelity in the 100-1000 nm feature-size regime.

A single layer for both grating and grating fill may use a photo-reactive coating where the local RI of the material is varied via photo-excitation. The examples of the materials and processes are illustrated in FIGS. 13A-13E and FIG. 14. These materials and processes may be adopted for forming SRG grating and grating fill layers.

In the hybrid resin-sol-gel material shown in FIG. 14, by incorporating an organic resin, thicker SnO(n)Cl(m) coatings may be made via spin-coating. The combination of sol-gel material and organic resin may allow one to maintain film photo-reactivity while increasing the thickness range for high-quality coatings to 1000 nm. However, when patterning the coating of hybrid resin-sol-gel material, the mixture has the ability to diffuse prior to final annealing, limiting the ability to retain pattern feature shapes with high fidelity to the micron range. Thus, using the hybrid resin-sol-gel materials to manufacture SRG gratings and grating-fillings in a single step is limited, since SRG features need to be imaged with high definition in the 100-500 nm range.

Thus, there is a need to increase the photo-pattern shape definition in thick SnO(n)Cl(m) photo-sol-gels such that they may be coated and cured to yield final thicknesses >1000 nm and can image feature in the 100-500 nm range with high fidelity. Any new material or approach should increase high-quality coating thickness without compromising the utility of the SnO(n)Cl(m) component to fabricate WG devices, such that the coating still shows a high base RI (>1.7 RI), responds to photo-excitation by varying the RI over a large RI window (>0.3 RI), and the absorption of all exposed and unexposed areas is <0.2%.

In some embodiments, the thickness and feature retention limitation of the SnO(n)Cl(m) coatings may be addressed by incorporating metal-oxide nanoparticles into the sol-gel material.

In various embodiments, the metal-oxide nanoparticles are compatible with the sol-gel solution without forming precipitates, and the resulting mixture may be coated to a high thickness via spin-coating, casting, IJP, or spray-coating. In addition, the metal-oxide nanoparticles may withstand extreme sol-gel environments while still being curable. For example, the metal-oxide nanoparticles should not degrade or lose the ability to be cured in the low pH of the sol-gel precursor, withstand the high temperature (>150° C.) used to cure the sol-gel, and may be stable towards the increase in absorption from yellowing or scattering. In addition, the nanoparticle-sol-gel mixture may be capable of condensing together via thermal treatment such that annealing leads to a permanent coating that may not be washed off with organic solvents during post-processing. Finally, the nanoparticle may not disrupt coordination chemistry around metal, so that the ability to form a high-density, amorphous sol-gel via condensation chemistry is still possible.

In some embodiments, nanoparticles may independently have a high RI (>1.6), and incorporation into the sol-gel mixture does not reduce the base refractive index of the sol-gel component once cured. In various embodiments, the nanoparticle does not disrupt coordination chemistry around metal, such that photo-reactivity and condensation chemistry are maintained.

In various embodiments, the photochemistry of the sol-gel component may not be disrupted by the presence of the nanoparticles. As such, photo-patterning and curing of the mixture occur through orthogonal processes, and the ΔRI may be varied depending on device requirements without compromising whether the hybrid coating can be cured.

In some embodiments, a solution of the metal oxide nanoparticles with an engineered particle surface may be incorporated into the sol-gel precursor solution.

According to various embodiments, the metal oxide nanoparticle suspension may be mixed with solutions containing tin dichloride, an alcohol-containing solvent or solvent mixture, and optionally an acylate or methacrylate monomer or oligomer, an acrylate or methacrylate cross-linker, a photo-sensitizer such as a photo-acid generator, photo-base generator, photo-redox agent, or radical-initiator.

In some embodiments, the sol-gel material for optical coatings may be a solution containing tin dichloride salt, at least one alcohol-containing solvent, a nanoparticle, and optionally, an acylate or methacrylate monomer or oligomer, an acrylate or methacrylate cross-linker, a photo-sensitizer such as a photo-acid generator, photo-base generator, photo-redox agent, or radical-initiator. In some embodiments, a continuous coating containing SnO(n)X(m) mixed with the nanoparticle and optional resin matrix may be formed, whose n-m ratio and n-m values may be varied across the length of the coating dimensions as a result of selective photo-excitation followed by blanket thermal annealing, such that the local RI of the coating is varied without affecting the coating's transparency.

In some embodiments, tin dichloride salt in the coating precursor solution is anhydrous tin dichloride or tin dichloride hydrate. In some embodiments, tin(II) ions and chloride ions may be provided from separate salts.

In various embodiments, nanoparticles may have an average size of less than 50 nm (diameter). In some embodiments, nanoparticles may have a core containing TiO₂, Nb₂O₅, Ta₂O₅, ZrO₂, HfO₂, SnO₂, SnO, ZnS, ZnO, SiO₂, Al₂O₃ or BaTiO₃. In various embodiments, nanoparticles may optionally contain a passivating metal oxide shell such as ZrO₂, HfO₂, ZnS, SiO₂, Al₂O₃, ZnO, or Ta₂O₅. In some instances, nanoparticles may be surface passivated with phosphate, siloxane, or silicate species. In other embodiments, the nanoparticle may be optionally surface-treated with organic species with low Sn-coordination strength that can prevent aggregation. In certain embodiments, the nanoparticle may be optionally surface-treated with methacrylate or acrylate-containing species. In various embodiments, the nanoparticles form a suspension when mixed with the sol-gel precursor that is stable (does not precipitate) for at least 30 minutes.

In some embodiments, the coating precursor solution may contain a solvent or solvent mixture that includes at least one alcohol, such as alkyl alcohol, glycol, or diol.

In some embodiments, the solvent mixture for the precursor solution includes at least one of the following solvents: dipropylene glycol monomethyl ether (DPGME), propylene glycol monomethyl ether (PGME), ethanol, isopropanol, propanol, diethylene glycol, propylene glycol methyl ether acetate, tripropylene glycol monomethyl ether, butyl lactate, propylene carbonate, methanol, and water.

In various embodiments, the coating solution optionally contains a photo-acid generator or a photo-acid. The photo-acid generator or photo-acid for the precursor solution may be at least one of the following compounds: triarylsulfonium compound, diazomethane compound, bis(sulfonyl)diazomethane compound, diaryliodonium compound, triarylselenonium compound, arene ferrocene compound, or sulfonic acid ester compound.

In some embodiments, a coating may be prepared from the precursor solution containing SnO(n)X(m) and nanoparticles. Once thermally annealed and optionally photo-cured, the coating may display a RI between 1.50 and 2.35 where all portions of the film show absorption values <0.1% in the visible spectrum.

In various embodiments, a coating composed of SnO(n)X(m) and nanoparticles has variable n-m values and n:m ratio resulting from selective photo-curing of the coating prior to completing the thermal annealing process, such that local RI values vary from 1.65 to 2.35 and wherein all portions of the film show absorption values <0.1% in the visible spectrum.

In some embodiments, region(s) of the coating may be selectively photo-exposed, and such regions may display RI values that are lower than the non-photo-exposed regions, and the photo-exposed regions have an n value between 1.5-2.2 and an m:n ratio >3.

In certain embodiments, a coating may have m-n values where the m:n ratio and resulting local RI values may be controlled by the intensity, time, and wavelength of photo-excitation, followed by thermal annealing.

In some embodiments, a process may include applying the precursor solution onto a substrate via spin-coating, ink-jet printing, dip-coating, spray-coating, screen-printing, contact-printing, or casting. In some embodiments, a portion of the coated layer may be cured using a light source with an excitation wavelength ≥193 nm and power ≤300 mW/cm² for 0.001 to 600 seconds, where the photo-exposed areas display a lower RI value than the non-exposed areas after thermal annealing. In some embodiments, a portion of the coating may be photo-cured using a light pattern formed by constructive and destructive interference to create a (latent) holographic optical element (e.g., VBG) within the coating following thermal annealing. Optionally, photo-curing a portion of the coating through a binary mask with features ranging from 100 nm to 20 cm in dimensions to create a pattern of periodic variation in the RI and thickness within the coating following thermal annealing. The substrate with the photo-cured coating may be thermally annealed via at least 1 stage of thermal annealing after photo-excitation, at annealing temperatures <300° C. In some embodiments, the coating may be thermally annealed via at least 2 stages of annealing, where the initial annealing may occur before or after the photo-excitation step, where the temperature of the first anneal step is <150° C. and the temperature of the final anneal step is <300° C. After the thermal annealing, a transparent coating with local variations in RI may be formed, where the local RI may vary by at least 0.1 and the overall RI variation may be in the range of 1.50-2.35.

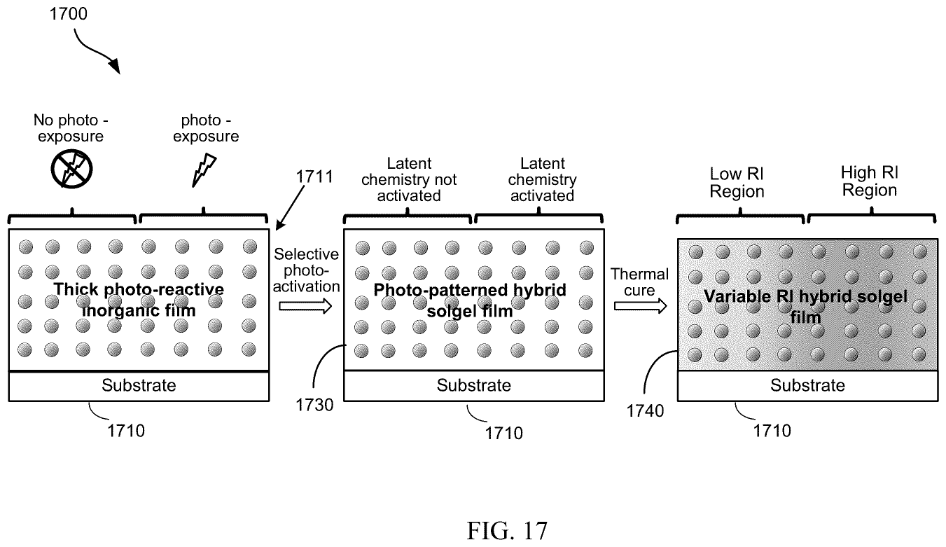

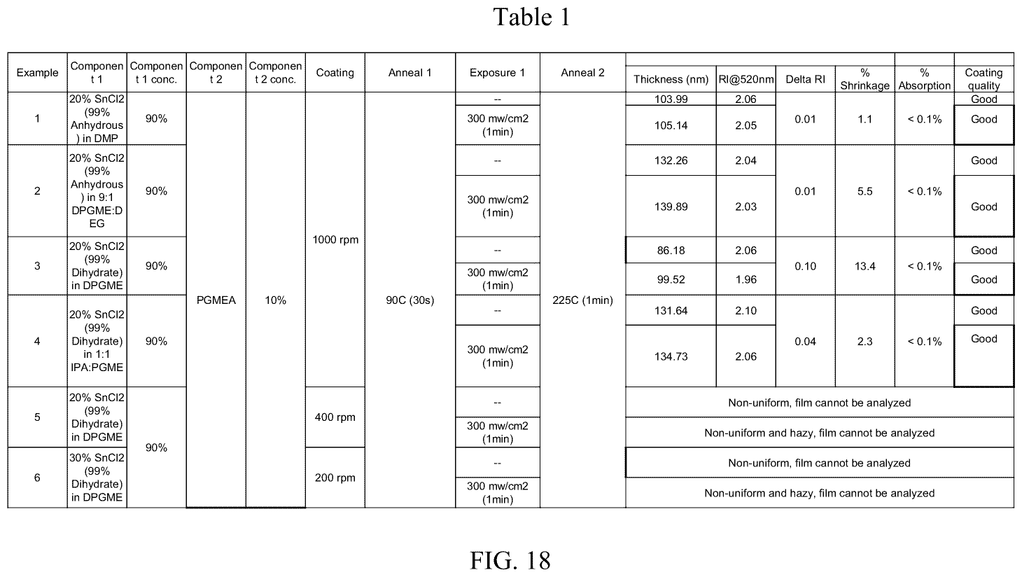

FIG. 17 illustrates an example of a process 1700 of fabricating optical devices using photo-patternable sol-gel material incorporating high-RI nanoparticles with selective photo-activation and refractive index modulation by latent chemistry. As illustrated in FIG. 17, in process 1700, a thick photo-reactive inorganic film 1711 containing high-RI nanoparticles may be formed on a substrate 1710. The film 1711 may undergo selective photo-activation where one or more regions of the film 1711 may be exposed to light. Selective photo-activation forms a thick photo-patterned film 1730, where the photo-exposed regions can be further activated by latent chemistry. The thick photo-patterned film 1730 is thermally cured to form a thick film 1740 with variable RI. The photo-exposed, latent-chemistry-activated regions of the film 1740 may have a high RI, whereas the unexposed regions of the film may have a low RI. Experimental results of comparative examples and working examples are shown in the tables in FIGS. 18-29.

### Experimental Results

### Hybrid-Resin-Sol-Gel

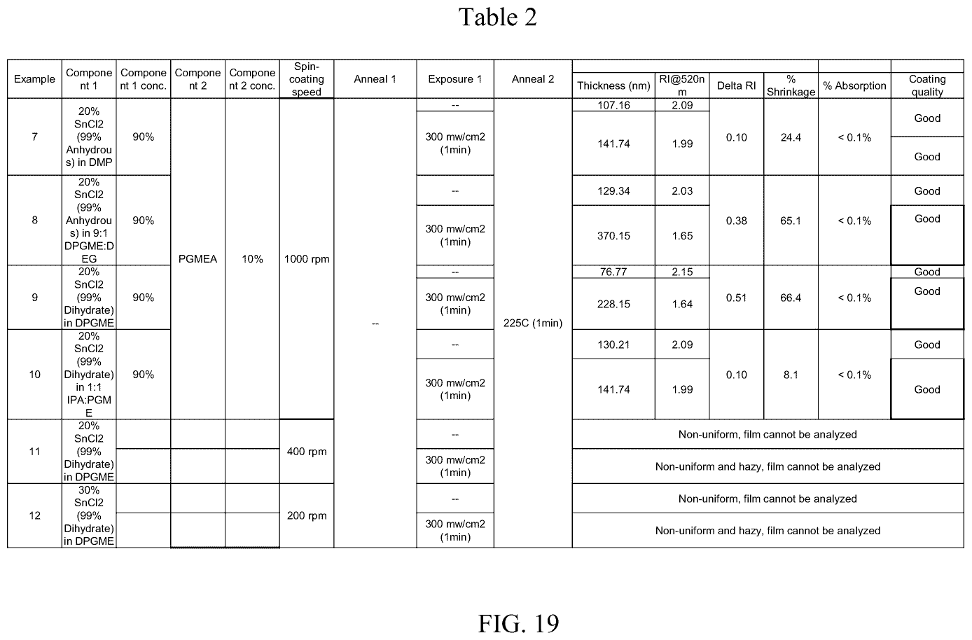

Different solutions containing tin(II) dichloride salt and an alcohol-containing organic solvent were prepared. The solutions were then deposited onto a substrate via spin-coating at different speeds (to control deposit thickness) and optionally processed via a first anneal by heating the coating at 90° C. for 30 seconds. The introduction of this anneal step changes the potential mobility and reactivity of coating components by the partial removal of solvent and partial condensation of inorganic components. Each sample was then partially exposed to photo-excitation and each sample was annealed at 225° C. for 1 minute to form a permanent coating. The RI and thickness of the coatings were measured via ellipsometry, and the change in RI and thickness accompanying selective photo-curing is displayed in Table 1 in FIG. 18 and Table 2 in FIG. 19.

These examples show that there is photo-reactivity within the mixture of Sn(II) dichloride and alcohol-containing solvents. When the spin-coating speed is 1000 rpm, the change in RI is higher both when the coating is annealed prior to selective photo-curing and when no pre-annealing takes place. The maximum coating thickness after full processing is at least <400 nm. Direct photo-excitation of the tin mixture provides an RI change as high as 0.5, at the expense of larger changes in final coating thickness between exposed and unexposed areas. The highest RI for a non-exposed region in these examples is 2.15. There is no significant difference in RI between photo-exposed and non-photo-exposed areas prior to the final anneal, suggesting that this photo-patterning technique relies on creating a pattern of latent chemistry that comes through as a sharp change in optical properties during post-processing. All examples, regardless of curing protocol, are highly transparent with absorption values across the visible spectrum <0.1%.

When the spin-coating speed is significantly reduced to increase the final coating thickness, the resulting films are non-uniform or hazy. There is a visual change to the film quality after photo-excitation and subsequent 225° C. annealing, but the film quality is too poor for a reliable measurement of film thickness and RI via ellipsometry.

These examples show that direct photo-excitation of the Sn-alcohol solvent system provides a latent chemistry photo-patterning approach for thin coatings. The fact that all unexposed areas in these examples show higher RI than exposed areas suggests that photo-excitation eases the direct transition to a phase richer in Sn(IV)O₂. That is, photo-excitation leads to higher m values and higher m:n ratios in the SnO(n)Cl(m) system. Without being bound by theory, these results suggest that photo-excitation enables the chemical environment around the Sn center to be more readily oxidized, or enables any of the surrounding moieties to readily function as an oxo-ligand donor. However, it is difficult to produce a film with a thickness greater than 1000 nm via spin-coating since the Sn-salt and alcohol solutions result in poor film quality. Thus, a new materials approach is needed to extend the thickness range of SnOCl-based photo-reactive coatings.

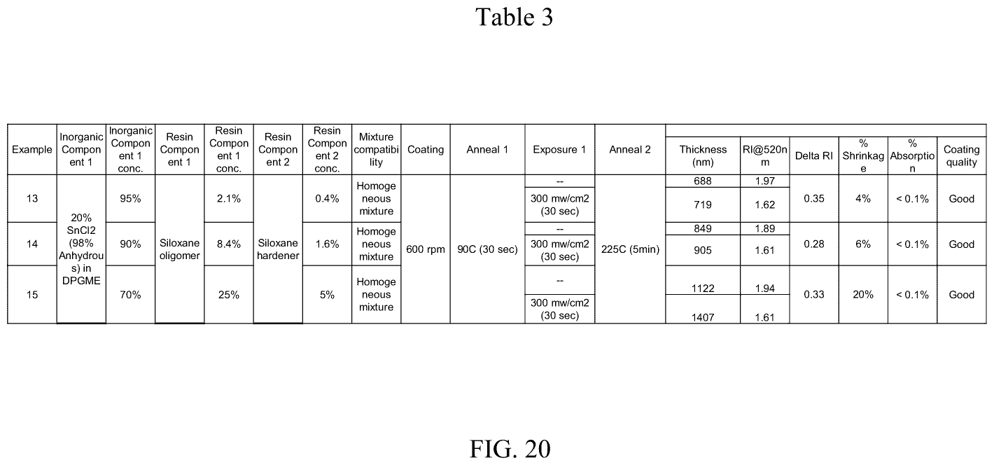

Table 3 in FIG. 20 shows the experimental results for examples 13-15. In examples 13-15, the experiments corresponding to examples 1-12 were repeated with solutions containing anhydrous tin(II) dichloride in DPGME, siloxane oligomer consisting of diarylsiloxane repeating units, and tetraethyl orthosilicate hardener component containing 1% of platinum catalyst. The ratio of the oligomer and hardener components was kept at 5:1 by weight, and the overall silicone mixture content was gradually increased from Example 13 to Example 15. The result of the experiment is summarized in Table 3.

Examples 13-15 produced a homogeneous solution, indicating precursor compatibility between SnOCl solution and silicone mixture. Upon curing, the overall thickness of the coatings increased significantly compared to the SnOCl-only coatings, and the photo-exposed portion of the samples showed higher thicknesses and lower RI. In all cases, a good coating quality was achieved, and the absorption of the coatings was <0.1% across the visible spectrum. Together, these results indicate that the silicone matrix can be used to increase the thickness range of the SnOCl sol-gel without disturbing its photo-reactivity or decreasing coating quality.

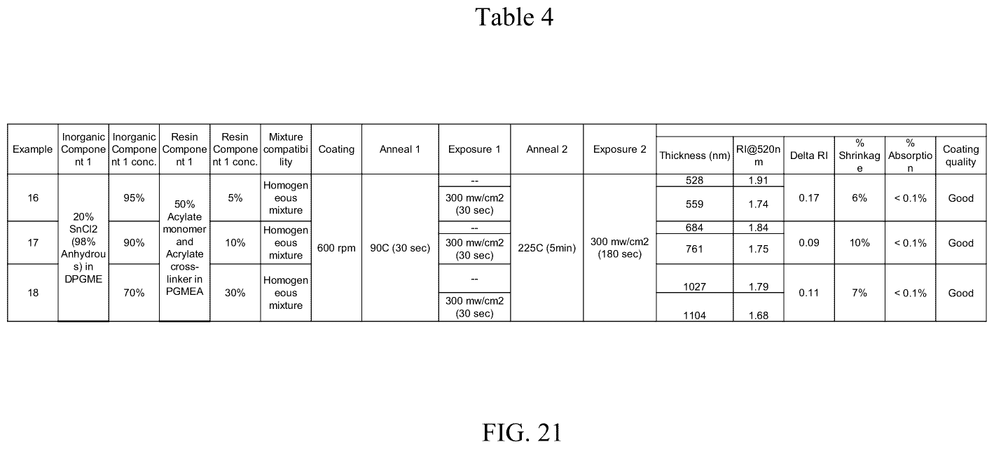

Table 4 in FIG. 21 shows the experimental results for examples 16-18. In examples 16-18, experiments corresponding to examples 1-12 were repeated with solutions containing anhydrous tin(II) dichloride in DPGME and a mixture of aryl acrylate monomer, trimethylolpropane triacrylate cross-linker, and phosphine oxide photo-initiator in PGMEA. The overall acrylate mixture content was gradually increased from Example 16 to Example 18. After the second anneal, a second blanket UV cure was implemented to ensure that all acrylate components reacted. The result of the experiment is summarized in Table 4.

Examples 16-18 produced a homogeneous solution of all components, indicating the precursor compatibility between SnOCl solution and acrylate mixture. Upon curing, the overall thickness of the coatings increased significantly from the SnOCl-only coatings, while the photo-exposed portion of the samples showed higher thicknesses and lower RI. In all cases, a good coating quality was achieved, and the absorption of the coatings was <0.1% across the visible spectrum. Together, these results indicate that the polyacrylate matrix can be used to increase the thickness range of the SnOCl sol-gel without disturbing its photo-reactivity or decreasing coating quality.

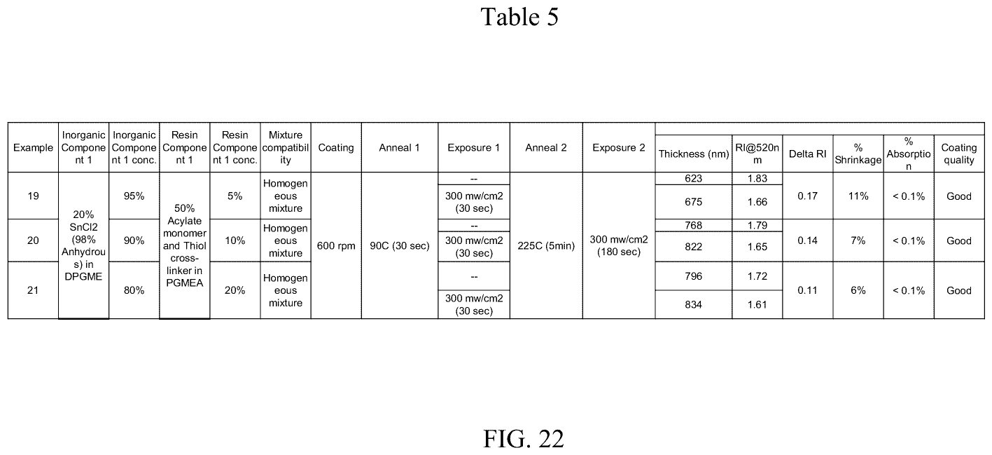

Table 5 in FIG. 22 shows the experimental results for examples 19-21, where the experiments corresponding to examples 1-12 were repeated for solutions containing anhydrous tin(II) dichloride in DPGME and a mixture of aryl acrylate monomer, 2-ethyl-2-[(3-mercapto-1-oxopropoxy)methyl]propane-1,3-diyl bis[3-mercaptopropionate] cross-linker and phosphine oxide photo-initiator in PGMEA. The overall acrylate mixture content was gradually increased from Example 19 to Example 21. After the second anneal, a second blanket UV cure was implemented in order to ensure that all acrylate components reacted. The result of the experiment is summarized in Table 5.

Examples 19-21 produced a homogeneous solution of all components, indicating that there is precursor compatibility between SnOCl sol-gel and acrylate-thiol mixture. Upon curing, the overall thickness of the coatings increased from the SnOCl-only coatings, while the photo-exposed portion of the samples showed higher thicknesses and lower RI. In all cases, a good coating quality was achieved, and the absorption of the coatings was <0.1% across the visible spectrum. Together, these results indicate that the polysulfide matrix can be used to increase the thickness range of the SnOCl sol-gel without disturbing its photo-reactivity or decreasing coating quality.

SnO(n)X(m) with Metal-Oxide Nanoparticles

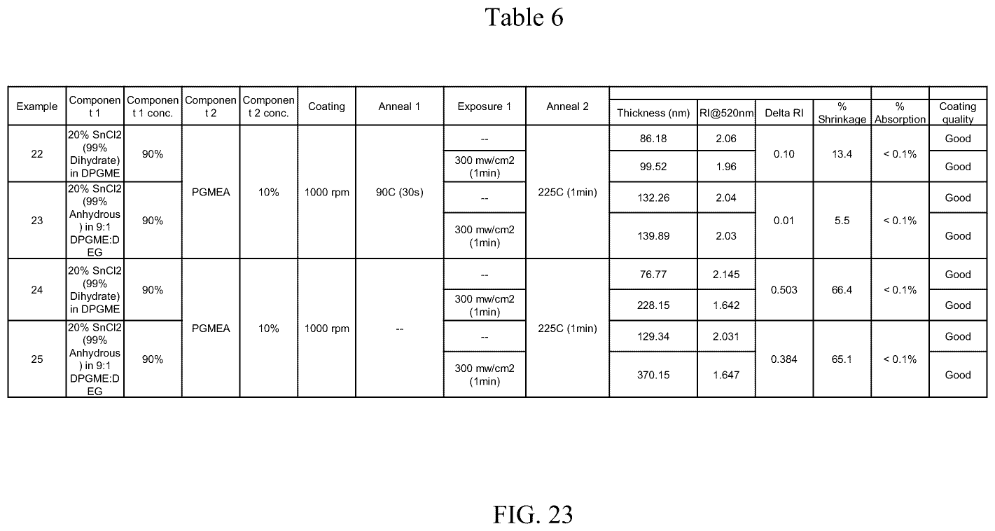

Different solutions containing tin(II) dichloride salt and an alcohol-containing organic solvent were prepared. The solutions were then deposited onto a substrate via spin-coating at different speeds (to control deposit thickness) and optionally processed via a first anneal consisting of heating the coating at 90° C. for 30 seconds. The introduction of this anneal step changes the potential mobility and reactivity of coating components as a result of the partial removal of solvent and partial condensation of inorganic components. Each sample was then partially exposed to photo-excitation and each sample was annealed at 225° C. for 1 minute, resulting in in a set coating that cannot be washed with solvent. The RI and thickness of the coatings were measured via ellipsometry and the change in RI and thickness accompanying selective photo-curing are displayed in Table 6 in FIG. 23.

These comparative examples 22-25 show that there is photo-reactivity within the mixture of Sn(II) dichloride and alcohol-containing solvents. The change in RI is significantly higher without pre-annealing. In all cases, the maximum coating thickness after full processing is at least <400 nm. Direct photo-excitation of the tin mixture provides an RI change as high as 0.5, at the expense of larger changes in final coating thickness between exposed and unexposed areas. All areas, regardless of curing protocol, are highly transparent with absorption values across the visible spectrum <0.1%.

When the spin-coating speed is significantly reduced to increase the final coating thickness, the resulting films are non-uniform or hazy. There is a visual change in film quality when upon photo-excitation and subsequent 225° C. annealing, but the film quality is too poor to produce a reliable measurement of film thickness and RI via ellipsometry.

The examples 22-25 show that direct photo-excitation of the Sn-alcohol solvent system provides a latent chemistry photo-patterning approach for thin coatings. The fact that all unexposed areas in this example show higher RI than exposed areas suggests that photo-excitation eases the direct transition to a phase richer in Sn(IV)O₂. That is, photo-excitation leads to higher m values and higher m:n ratios in the SnO(n)Cl(m) system. Without being bound by theory, these results suggest that photo-excitation enables the chemical environment around the Sn center to be more readily oxidized, or enables any of the surrounding moieties to readily function as an oxo-ligand donor. However, it is not possible to produce a film with thickness >1000 nm via spin-coating, since the Sn-salt and alcohol solutions result in poor film quality. Thus, a new materials approach is needed to extend the thickness range of SnOCl-based photo-reactive coatings.

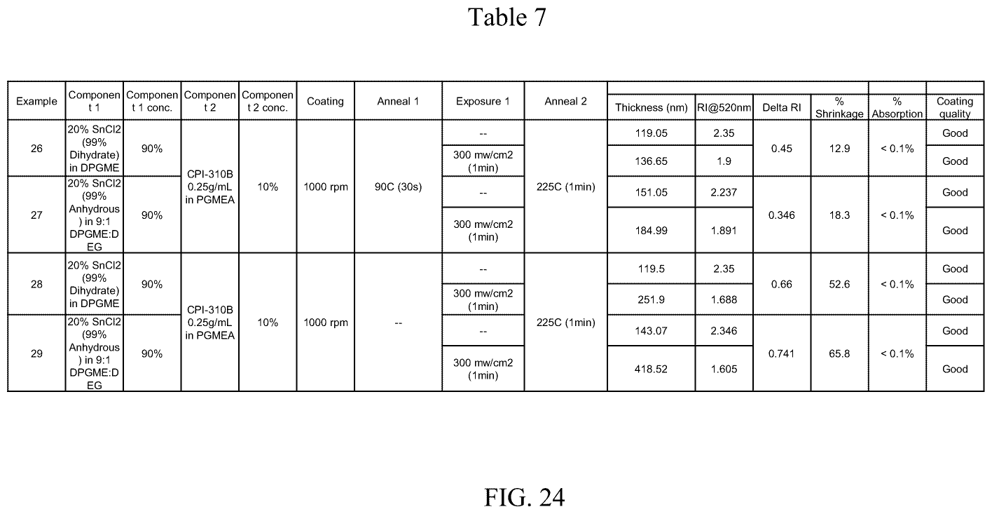

Table 7 in FIG. 24 shows the experimental results for examples 26-29, where the experiments corresponding to examples 22-25 were repeated for a formulation that contained a photo-acid generator (PAG) in addition to SnCl₂ and an alcohol solvent. It was found that the addition of the PAG increased the change in RI upon photo-excitation. The film quality at ˜400 nm remained good, and the absorption of the coating was <0.1% in all cases, but the thickness did not increase to 1000 nm without decreasing the quality of the coating or producing a hazy film. Thus, a new materials approach is necessary to extend the thickness range to thicker film.

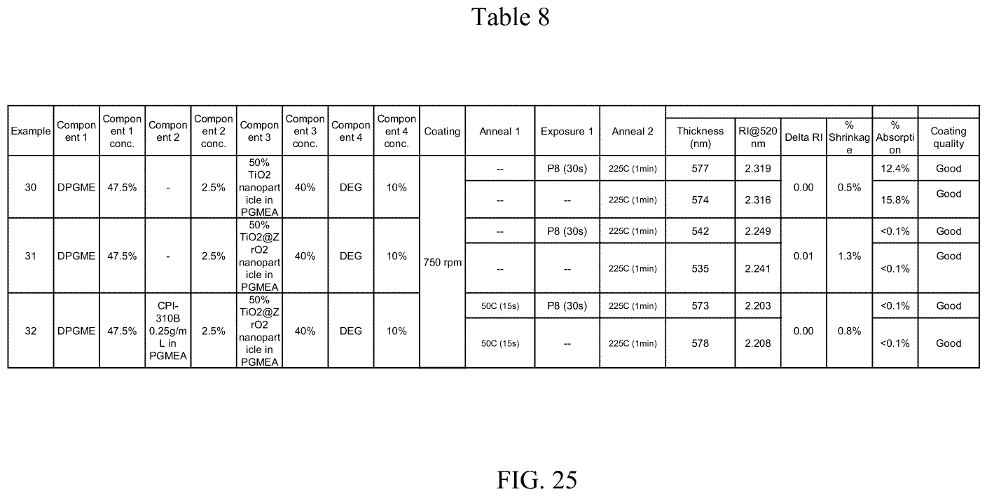

Table 8 in FIG. 25 shows the experimental results for examples 30-32, where the experiments corresponding to examples 22-25 were repeated for a formulation that contained different TiO₂-based nanoparticles and an alcohol solvent. In all cases, photo-excitation, even in the presence of a PAG, did not change the RI of the coating significantly. In example 30, the TiO₂ particle was not protected by a metal oxide shell, so heating resulted in a significant increase in absorption. In examples 31 and 32, the TiO₂ core was protected with a ZrO₂ shell, so the absorption upon annealing remained <0.1%. In all cases, the thickness of the coating was >500 nm, potentially showing that a passivated TiO₂ nanoparticle could be used to increase the thickness of the coating without an increase in absorption when the nanoparticle surface is properly engineered.

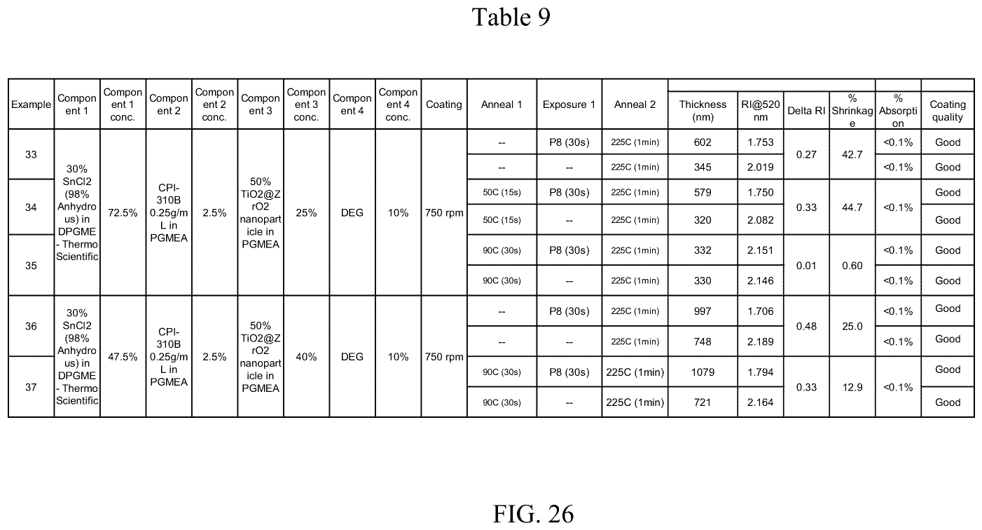

Table 9 in FIG. 26 shows the experimental results for examples 33-37, where the experiments corresponding to examples 22-25 were repeated for a formulation that contains SnCl₂, TiO₂ nanoparticles with ZrO₂ shell, and solvents. By controlling the ratio of Sn-salt to nanoparticles, it is possible to create coatings with a thickness >1000 nm and retain a low absorption value of the coating with a large ΔRI response. It is possible to pre-dry the coating prior to photo-exposure via a low-temperature anneal and still retain the optical properties of the material.

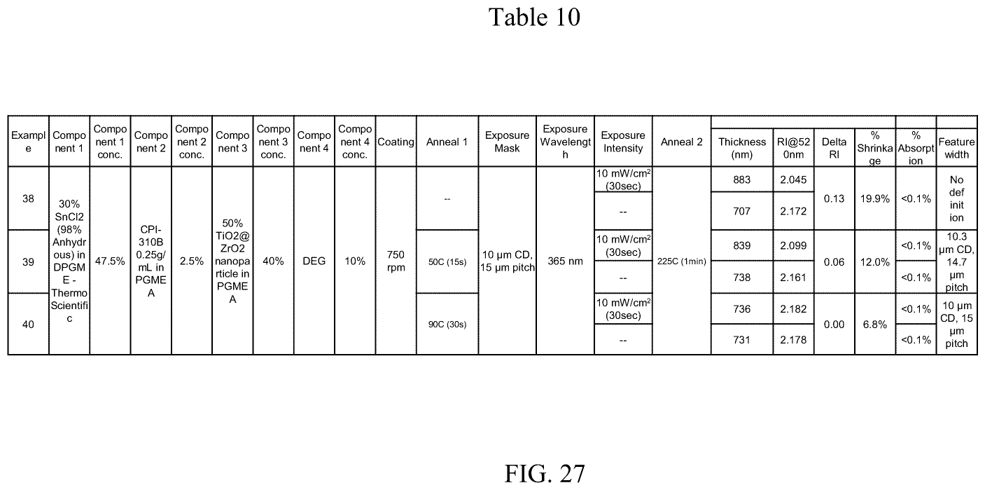

Table 10 in FIG. 27 shows the experimental results for examples 38-40, where the experiments corresponding to examples 22-25 were repeated for a formulation that contains SnCl₂, TiO₂ nanoparticles with a ZrO₂ shell, and solvents, with the exception that photo-exposure with 365 nm light was used to carry out a photo-patterning through a mask having 10 μm-wide lines with a 15 μm pitch. The coating was subjected to different degrees of pre-drying prior to photo-exposure, and the resolution of the imaged features was determined after the final anneal via SEM. It was found that it is possible to retain the feature shape and size upon pre-drying the coating at 90° C. Furthermore, the coating thickness was significantly higher than that of the nanoparticle-free examples 22-29. This shows that it is possible to image thicker films with high definition in the 10 μm-scale.

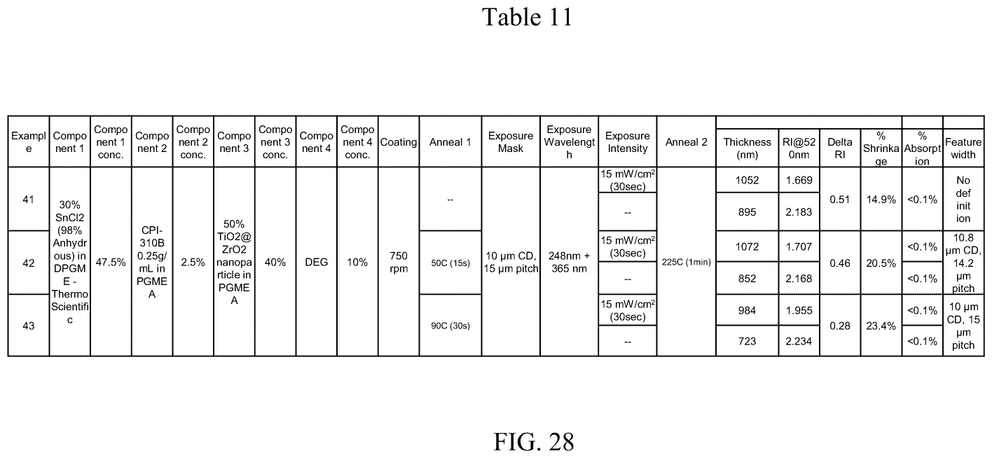

Table 11 in FIG. 28 shows the experimental results for examples 41-43, where the experiments corresponding to examples 38-40 were repeated, with the exception that photo-exposure was performed with 248 nm light. It was found that it is possible to retain the feature shape and size upon pre-drying the coating at 90° C. Furthermore, the change in RI was significantly larger and resulted in films that were >1000 nm in the exposed regions. This shows that it is possible to image thick films with a thickness of about 1000 nm and high definition in the 10 μm-scale.

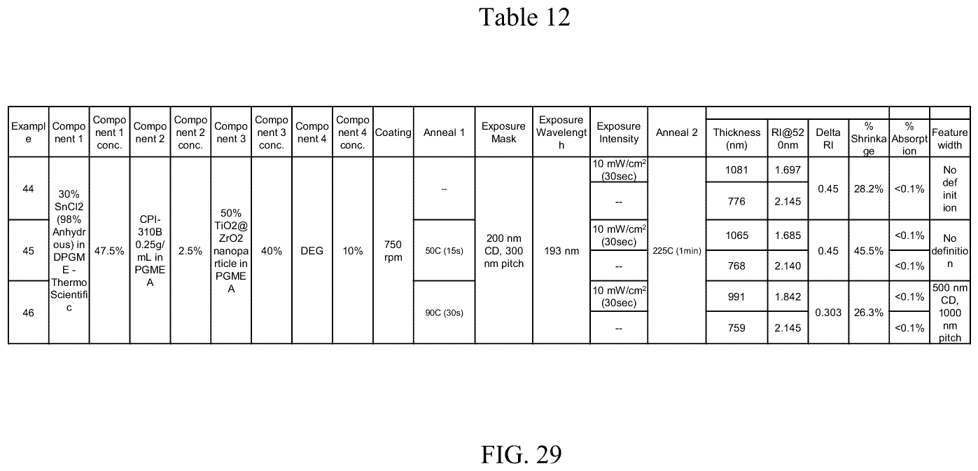

Table 12 in FIG. 29 shows the experimental results for examples 44-46, where the experiments corresponding to examples 38-40 were repeated, with the exception that photo-exposure was conducted with 193 nm light and the mask contained 500 nm features with 1000 nm pitch. It was found that it is possible to retain the feature shape and size upon pre-drying the coating at 90° C. Furthermore, the change in RI was significantly larger and resulted in films that were >1000 nm in the exposed regions. This shows that it is possible to image thick films with a thickness of about 1000 nm and high definition in the hundreds of nm scale.

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

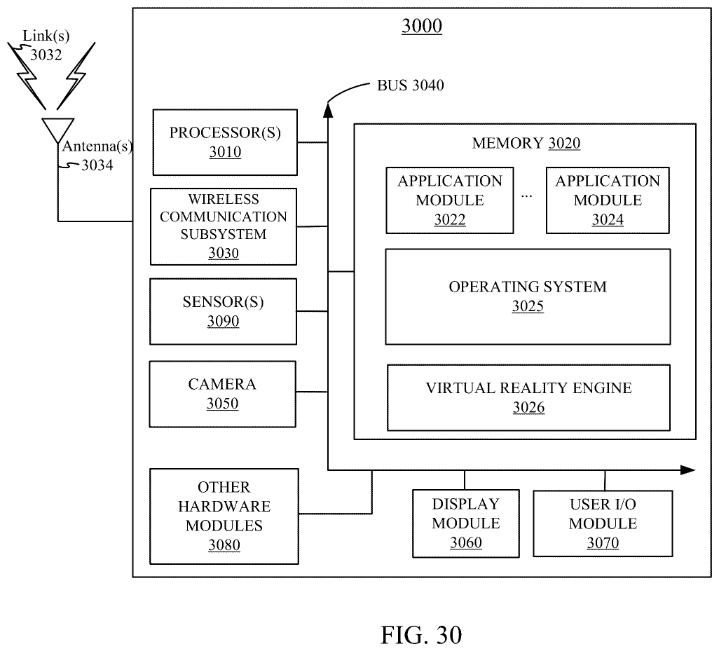

FIG. 30 is a simplified block diagram of an example of an electronic system 3000 of a near-eye display system (e.g., HMD device) for implementing some of the examples disclosed herein. Electronic system 3000 may be used as the electronic system of an HMD device or other near-eye displays described above. In this example, electronic system 3000 may include one or more processor(s) 3010 and a memory 3020. Processor(s) 3010 may be configured to execute instructions for performing operations at a number of components, and can be, for example, a general-purpose processor or microprocessor suitable for implementation within a portable electronic device. Processor(s) 3010 may be communicatively coupled with a plurality of components within electronic system 3000. To realize this communicative coupling, processor(s) 3010 may communicate with the other illustrated components across a bus 3040. Bus 3040 may be any subsystem adapted to transfer data within electronic system 3000. Bus 3040 may include a plurality of computer buses and additional circuitry to transfer data.

Memory 3020 may be coupled to processor(s) 3010. In some embodiments, memory 3020 may offer both short-term and long-term storage and may be divided into several units. Memory 3020 may be volatile, such as static random access memory (SRAM) and/or dynamic random access memory (DRAM) and/or non-volatile, such as read-only memory (ROM), flash memory, and the like. Furthermore, memory 3020 may include removable storage devices, such as secure digital (SD) cards. Memory 3020 may provide storage of computer-readable instructions, data structures, program modules, and other data for electronic system 3000. In some embodiments, memory 3020 may be distributed into different hardware modules. A set of instructions and/or code might be stored on memory 3020. The instructions might take the form of executable code that may be executable by electronic system 3000, and/or might take the form of source and/or installable code, which, upon compilation and/or installation on electronic system 3000 (e.g., using any of a variety of generally available compilers, installation programs, compression/decompression utilities, etc.), may take the form of executable code.

In some embodiments, memory 3020 may store a plurality of application modules 3022 through 3024, which may include any number of applications. Examples of applications may include gaming applications, conferencing applications, video playback applications, or other suitable applications. The applications may include a depth sensing function or eye tracking function. Application modules 3022-3024 may include particular instructions to be executed by processor(s) 3010. In some embodiments, certain applications or parts of application modules 3022-3024 may be executable by other hardware modules 3080. In certain embodiments, memory 3020 may additionally include secure memory, which may include additional security controls to prevent copying or other unauthorized access to secure information.

In some embodiments, memory 3020 may include an operating system 3025 loaded therein. Operating system 3025 may be operable to initiate the execution of the instructions provided by application modules 3022-3024 and/or manage other hardware modules 3080 as well as interfaces with a wireless communication subsystem 3030 which may include one or more wireless transceivers. Operating system 3025 may be adapted to perform other operations across the components of electronic system 3000 including threading, resource management, data storage control and other similar functionality.

Wireless communication subsystem 3030 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 3000 may include one or more antennas 3034 for wireless communication as part of wireless communication subsystem 3030 or as a separate component coupled to any portion of the system. Depending on desired functionality, wireless communication subsystem 3030 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 3030 may permit data to be exchanged with a network, other computer systems, and/or any other devices described herein. Wireless communication subsystem 3030 may include a means for transmitting or receiving data, such as identifiers of HMD devices, position data, a geographic map, a heat map, photos, or videos, using antenna(s) 3034 and wireless link(s) 3032. Wireless communication subsystem 3030, processor(s) 3010, and memory 3020 may together comprise at least a part of one or more of a means for performing some functions disclosed herein.

Embodiments of electronic system 3000 may also include one or more sensors 3090. Sensor(s) 3090 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 3090 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 3000 may include a display module 3060. Display module 3060 may be a near-eye display, and may graphically present information, such as images, videos, and various instructions, from electronic system 3000 to a user. Such information may be derived from one or more application modules 3022-3024, virtual reality engine 3026, one or more other hardware modules 3080, a combination thereof, or any other suitable means for resolving graphical content for the user (e.g., by operating system 3025). Display module 3060 may use liquid crystal display (LCD) technology, light-emitting diode (LED) technology (including, for example, OLED, ILED, μLED, AMOLED, TOLED, etc.), light emitting polymer display (LPD) technology, or some other display technology.

Electronic system 3000 may include a user input/output module 3070. User input/output module 3070 may allow a user to send action requests to electronic system 3000. An action request may be a request to perform a particular action. For example, an action request may be to start or end an application or to perform a particular action within the application. User input/output module 3070 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 3000. In some embodiments, user input/output module 3070 may provide haptic feedback to the user in accordance with instructions received from electronic system 3000. For example, the haptic feedback may be provided when an action request is received or has been performed.

Electronic system 3000 may include a camera 3050 that may be used to take photos or videos of a user, for example, for tracking the user's eye position. Camera 3050 may also be used to take photos or videos of the environment, for example, for VR, AR, or MR applications. Camera 3050 may include, for example, a complementary metal-oxide-semiconductor (CMOS) image sensor with a few millions or tens of millions of pixels. In some implementations, camera 3050 may include two or more cameras that may be used to capture 3-D images.

In some embodiments, electronic system 3000 may include a plurality of other hardware modules 3080. Each of other hardware modules 3080 may be a physical module within electronic system 3000. While each of other hardware modules 3080 may be permanently configured as a structure, some of other hardware modules 3080 may be temporarily configured to perform specific functions or temporarily activated. Examples of other hardware modules 3080 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 3080 may be implemented in software.

In some embodiments, memory 3020 of electronic system 3000 may also store a virtual reality engine 3026. Virtual reality engine 3026 may execute applications within electronic system 3000 and receive position information, acceleration information, velocity information, predicted future positions, or some combination thereof of the HMD device from the various sensors. In some embodiments, the information received by virtual reality engine 3026 may be used for producing a signal (e.g., display instructions) to display module 3060. For example, if the received information indicates that the user has looked to the left, virtual reality engine 3026 may generate content for the HMD device that mirrors the user's movement in a virtual environment. Additionally, virtual reality engine 3026 may perform an action within an application in response to an action request received from user input/output module 3070 and provide feedback to the user. The provided feedback may be visual, audible, or haptic feedback. In some implementations, processor(s) 3010 may include one or more GPUs that may execute virtual reality engine 3026.

In various implementations, the above-described hardware and modules may be implemented on a single device or on multiple devices that can communicate with one another using wired or wireless connections. For example, in some implementations, some components or modules, such as GPUs, virtual reality engine 3026, and applications (e.g., tracking application), may be implemented on a console separate from the head-mounted display device. In some implementations, one console may be connected to or support more than one HMD.

In alternative configurations, different and/or additional components may be included in electronic system 3000. Similarly, functionality of one or more of the components can be distributed among the components in a manner different from the manner described above. For example, in some embodiments, electronic system 3000 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, and the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A photo-sensitive sol-gel material comprising:
an alcohol-containing solvent; and
a tin dichloride salt and metal oxide nanoparticles mixed with the alcohol-containing solvent,
wherein the photo-sensitive sol-gel material, upon deposition, selective photo-excitation, and thermal annealing, forms a film including SnO(n)X(m) and the metal oxide nanoparticles, and wherein at least one of an m:n ratio, an n value, or an m value of SnO(n)X(m) varies across regions of the film as a result of the selective photo-excitation and thermal annealing, such that a refractive index of the film varies across the regions of the film.

2. The photo-sensitive sol-gel material of claim 1, wherein each of the metal oxide nanoparticles includes a core that includes at least one of TiO₂, Nb₂O₅, Ta₂O₅, ZrO₂, HfO₂, SnO₂, SnO, ZnS, ZnO, SiO₂, Al₂O₃, or BaTiO₃.

3. The photo-sensitive sol-gel material of claim 1, wherein each of the metal oxide nanoparticles includes a passivating metal oxide shell that includes at least one of ZrO₂, HfO₂, ZnS, SiO₂, Al₂O₃, ZnO, or Ta₂O₅.

4. The photo-sensitive sol-gel material of claim 1, wherein surfaces of the metal oxide nanoparticles are passivated with at least one of phosphate species, siloxane species, or silicate species.

5. The photo-sensitive sol-gel material of claim 1, wherein the tin dichloride salt comprises at least one of:
an anhydrous tin dichloride;
a tin dichloride hydrate; or
tin(II) ions and chloride ions from separate salts.

6. The photo-sensitive sol-gel material of claim 1, wherein the alcohol-containing solvent comprises at least one of an alkyl alcohol, a glycol, or a diol.

7. The photo-sensitive sol-gel material of claim 1, further comprising at least one of:
an acylate or methacrylate monomer or oligomer, or
an acrylate or methacrylate cross-linker.

8. The photo-sensitive sol-gel material of claim 1, further comprising a photo-sensitizer that includes at least one of a photo-acid generator or a photo-acid.

9. The photo-sensitive sol-gel material of claim 8, wherein the photo-acid generator or photo-acid comprises at least one of a triarylsulfonium compound, a diazomethane compound, a bis(sulfonyl)diazomethane compound, a diaryliodonium compound, a triarylselenonium compound, an arene ferrocence compound, or a sulfonic acid ester compound.

10. The photo-sensitive sol-gel material of claim 1, wherein the film formed after the selective photo-excitation and thermal annealing is characterized by the refractive index between 1.5 and 2.35 and an absorption value lower than 0.1% for visible light.

11. An optical device comprising an optical coating layer formed using the photo-sensitive sol-gel material of claim 1, wherein:
the optical coating layer includes SnO(n)X(m) and the metal oxide nanoparticles; and
at least one of the m:n ratio, the m value, or the n value of SnO(n)X(m) in the optical coating layer varies across regions of the optical coating layer, such that a refractive index of the optical coating layer varies across the regions of the optical coating layer.

12. The optical device of claim 11, wherein:
the refractive index of the optical coating layer varies between 1.5 and 2.35;
a refractive index modulation of the optical coating layer is greater than 0.1; and
the optical coating layer is characterized by an absorption value lower than 0.1% for visible light.

13. The optical device of claim 11, wherein photo-exposed regions of the optical coating layer have lower refractive index values than non-photo-exposed regions of the optical coating layer, the photo-exposed regions of the optical coating layer characterized by the refractive index values between 1.5 and 2.0 and the m:n ratio greater than 3.

14. A method comprising:
depositing a photo-sensitive sol-gel material on a substrate to form a coating layer, the photo-sensitive sol-gel material including:
an alcohol-containing solvent; and
a tin dichloride salt and metal oxide nanoparticles mixed with the alcohol-containing solvent;
selectively exposing regions of the coating layer to light having a wavelength greater than 193 nm; and
annealing the coating layer at an annealing temperature lower than 300° C.

15. The method of claim 14, wherein:
the regions of the coating layer exposed to the light and non-exposed regions of the coating layer have different refractive index values after thermal annealing; and
selectively exposing the regions of the coating layer to the light includes selectively exposing the regions of the coating layer to light with an intensity no more than 300 mW/cm² for an exposure time between 0.001 seconds and 600 seconds, wherein at least one of the intensity, the exposure time, or the wavelength is selected to achieve target local refractive index values.

16. A photo-reactive sol-gel material comprising:
an alcohol-containing solvent; and
a tin dichloride salt and a resin mixture mixed with the alcohol-containing solvent,
wherein the photo-reactive sol-gel material, upon deposition, selective photo-excitation, and thermal annealing, forms a film including SnO(n)X(m), wherein at least one of an n:m ratio, an n value, or an m value of SnO(n)X(m) varies across regions of the film as a result of the selective photo-excitation and thermal annealing, such that a refractive index of the film varies across the regions of the film.

17. The photo-reactive sol-gel material of claim 16, wherein the resin mixture comprises at least one of a thermal silicone, an UV acrylate, an UV methacrylate, or an UV sulfide.

18. The photo-reactive sol-gel material of claim 16, wherein the tin dichloride salt comprises at least one of an anhydrous tin dichloride, a tin dichloride hydrate, or tin(II) ions and chloride ions from separate salts.

19. The photo-reactive sol-gel material of claim 16, wherein the alcohol-containing solvent comprises at least one of an alkyl alcohol, a glycol, a diol, or a combination thereof.

20. The photo-reactive sol-gel material of claim 16, further comprising a photo-sensitizer, the photo-sensitizer including at least one of a photo-acid generator, a photo-base generator, a photo-redox agent, or a radical initiator.
